(19) United States
(12) Patent Application Publication
(10) Pub. No.: US 2026/0141592 A1
(43) Pub. Date: May 21, 2026

(54) System and Method for Automatic Creation of Product Photoshoots that Seamlessly Combine Real-Life Image Portions and Artificial Intelligence (AI) Generated Portions

(71) Applicant: CLOUDINARY LTD., Petah Tikva (IL)

(72) Inventors: Amnon Cohen-Tidhar, Zoran (IL); Daniel Cohen, Hod HaSharon (IL); Tal Lev-Ami, Modiin (IL)

(21) Appl. No.: 18/950,311

(22) Filed: Nov. 18, 2024

(51) Int. Cl. G06T 11/60

(52) U.S. Cl. CPC G06T 11/60

(57) ABSTRACT

Automatic creation of product photoshoots that seamlessly combine real-life image portions and Artificial Intelligence (AI) generated portions. An input photograph of a product is received, and a background-removed version is generated. The image is fed into a Vision and Language Model (VLM) that generates textual attributes that pertain to the product. The textual attributes are fed into a Large Language Model (LLM), that generates a proposed textual prompt that will command an Image Diffusion unit to generate via Generative AI an image of a scenery that would be appropriate for showcasing that product. The AI-generated image is fed into an AI-based unit that detects and cures visual abnormalities or visual distortions, with AI-based blending and refinement. The method generates a high-definition abnormality-free and distortion-free output image that depicts the real-world product blended seamlessly within the Generative-AI scenery. A similar process performs virtual staging of a room or a house or other venue.

### FIELD

Some embodiments are related to the field of digital content creation, and particularly to the field of creation of digital images.

### BACKGROUND

Electronic devices and computing devices are utilized on a daily basis by millions of users worldwide. For example, laptop computers, desktop computers, smartphone, tablets, and other electronic devices are utilized for browsing the Internet, consuming digital content, streaming audio and video, sending and receiving electronic mail (email) messages, engaging in Instant Messaging (IM) and video conferences, playing games, or the like.

Digital images and digital videos are often sent and received among users, are posted or shared by users via social networks, and are part of content shown on a variety of websites.

### SUMMARY

Some embodiments include systems, devices, and methods for automatic creation of product photoshoots combining real-life image portions and Artificial Intelligence (AI) generated portions; such as, an image the combines a photograph of a real-life object and an AI-generated background or scenery; or an image that combines a photograph of a real-life background or scenery with an AI-generated object; in a manner that creates a high-quality image that lacks visual “stitches” among the real-life portions and the AI-generated portions; and such that a human observer cannot distinguish (at all, or easily, or rapidly) which image-portions are AI-generated and which are taken from a photograph of a real-life object or scenery.

Automatic creation of product photoshoots that seamlessly combine real-life image portions and Artificial Intelligence (AI) generated portions. An input photograph of a product is received, and a background-removed version is generated. The image is fed into a Vision and Language Model (VLM) that generates textual attributes that pertain to the product. The textual attributes are fed into a Large Language Model (LLM), that generates a proposed textual prompt that will command an Image Diffusion unit to generate via Generative AI an image of a scenery that would be appropriate for showcasing that product. The AI-generated image is fed into an AI-based unit that detects and cures visual abnormalities or visual distortions, with AI-based blending and refinement. The method generates a high-definition abnormality-free and distortion-free output image that depicts the real-world product blended seamlessly within the Generative-AI scenery. A similar process performs virtual staging of a room or a house or other venue.

Some embodiments may provide other and/or additional benefits and/or advantages.

### BRIEF DESCRIPTION OF THE DRAWINGS

FIG. 1 is an illustration of a set of images demonstrating several stages in a Virtual Product Photoshoot, in accordance with some demonstrative embodiments.

FIG. 2 is a flow-chart demonstrating an automated method, in accordance with some demonstrative embodiments.

FIG. 3 is a flow-chart demonstrating a method of an image pre-processing phase, in accordance with some demonstrative embodiments.

FIG. 4 is an illustration of a set of images, in accordance with some demonstrative embodiments.

FIG. 5 is an illustration of a set of images, in accordance with some demonstrative embodiments.

FIG. 6 is an illustration of a set of images, in accordance with some demonstrative embodiments.

FIG. 7 is a flow-chart demonstrating a process of restoration of missing or cropped-out portions of a product in an image, in accordance with some demonstrative embodiments.

FIG. 8 is an illustration of a set of images, in accordance with some demonstrative embodiments.

FIG. 10 is a flow-chart demonstrating a process of prompt generation, in accordance with some demonstrative embodiments.

FIG. 11 is a flow-chart demonstrating a process of image diffusion, in accordance with some demonstrative embodiments.

FIG. 12 is an illustration of a set of images, produced and utilized in the image diffusion process, in accordance with some demonstrative embodiments.

FIGS. 13A to 13E are illustrations of sets of images demonstrating Virtual Home Staging, in accordance with some demonstrative embodiments.

### DETAILED DESCRIPTION OF SOME DEMONSTRATIVE EMBODIMENTS

The Applicant has realized that a photoshoot of a real-life object, such as a consumer product or other tangible item, can be a complex and expensive process. For example, realized the Applicant, a conventional photoshoot process may require meticulous planning and preparation, conceptualizing the theme and aesthetics, scouting suitable and available locations, setting up a studio, selecting and procuring appropriate props, staging physical objects, providing and operating lighting equipment, providing and operating camera equipment, and performing a other steps that are important for capturing the product or tangible object at its best. A conventional photoshoot process, realized the Applicant, can often be expensive, time-consuming, effort-consuming, error-prone, and/or logistically complex; and often necessitates coordination among numerous professionals, stylists, staging experts, lighting experts, procurement professionals, models, photographers, and other personnel. any alterations afterward can incur significant costs and time consumption. Moreover, realized the Applicant, conventional photoshoot process often requires post-production editing, modification, and/or digital enhancement of the captured images, which again can be labor-intensive, cost-intensive, time-consuming and/or error-prone.

The Applicant has realized that it may be beneficial to provide an innovative solution for a realistic photoshoot process, that maintains the full accuracy of the product or object being photographed, while also enabling a high level of creativity, all at a reduced cost and with fast or faster production times, and while reducing the complexities and the human efforts that are described above and that a conventional photoshoot process entails.

In accordance with some embodiments, an innovative method and system takes in a single photograph of the product/object, and an optional textual description of the required scene (e.g., a textual prompt). The system then autonomously generates via Generative AI (Gen-AI) the graphical image of the specified scene or scenery or background, and seamlessly integrates the product/object within it, resulting in a fully realistic composite image that preserves the integrity of the product/object of interest.

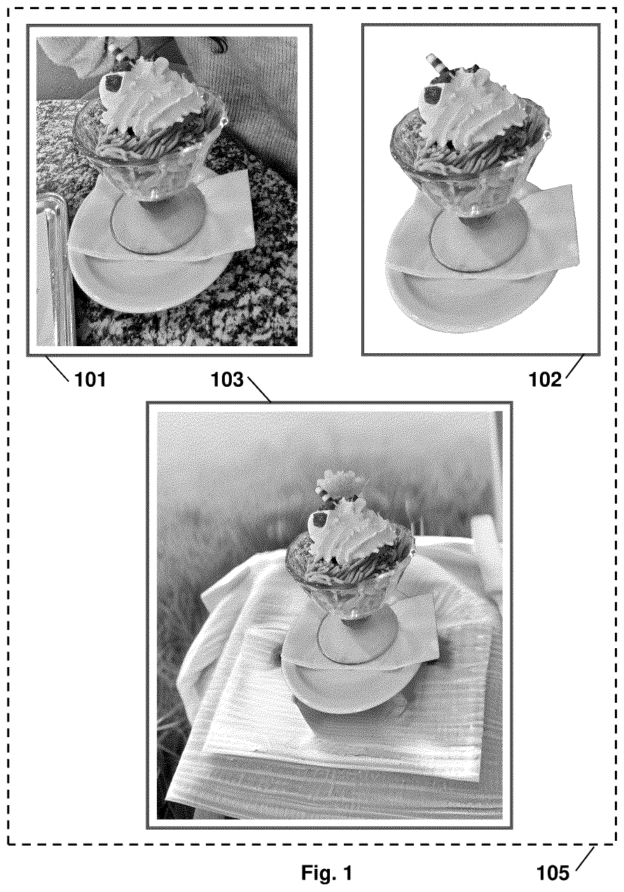

Reference is made to FIG. 1, which is an illustration of a set 105 of images in accordance with some demonstrative embodiments. Image 101 is a photograph of a real-life/real-world object or product, such as a photograph captured with a camera or smartphone or tablet. For example, image 101 shows a cup of ice cream, located on a plate with a napkin, on top of a marbled table, with a part of a human consumer located behind it.

The system of some embodiments receives a textual prompt, such as, “Please put the ice cream cup, with its napkin and plate, on a picnic table having a blue map and green grass in the background”. The system automatically processes image 101, and automatically generates from it image 102, which shows only the object/product of the ice cream cup—with the napkin and the plat, but without the table and the human consumer. Then, the system generates using a Generative AI engine the requested background or scenery, based on the textual prompt; and generates image 103 in which the image-portion of that real-life object (the ice cream cup with the napkin and the plate) is seamlessly integrated into that AI-generated scenery.

Some embodiments provide systems and methods for seamlessly integrating or embedding a photographed real-life/real-world object, into an AI-generated background/scene/scenery/environment. For example, a photograph of a real-life object is captured or received or otherwise obtained (e.g., downloaded or copy from a repository of photographs of real-world objects); the system uses a fine-tuned/specifically-trained AI engine, and/or a deterministic algorithm to remove some or all of the background from that photograph (e.g., leaving only the ice cream cup, in the above-mentioned example; or, leaving the ice cream cup with the napkin and the plate, but without the table and the human consumer). The system then utilizes Generative AI to generate a new image from a textual prompt and from the background-removed image; optionally with Generative AI outpainting that extends features or characteristics of the object towards or into its surroundings. The system then checks whether the resulting image caused distortion or abnormality to the object, or caused size-related errors or placement-related errors (e.g., the object is located partially on a table and partially in mid-air; the object is located on table having distorted legs), and a corrective phase is automatically performed to modify/replace/move/resize the object in the composed image with a corrected or improved or modified version thereof, in order to correct such distortions or abnormalities or visual errors. The system further operates to automatically homogenize the scene, such as, by modifying or introducing shades or lighting effects that uniformly affect both the real-world object portion and the AI-generated portion of the composed image.

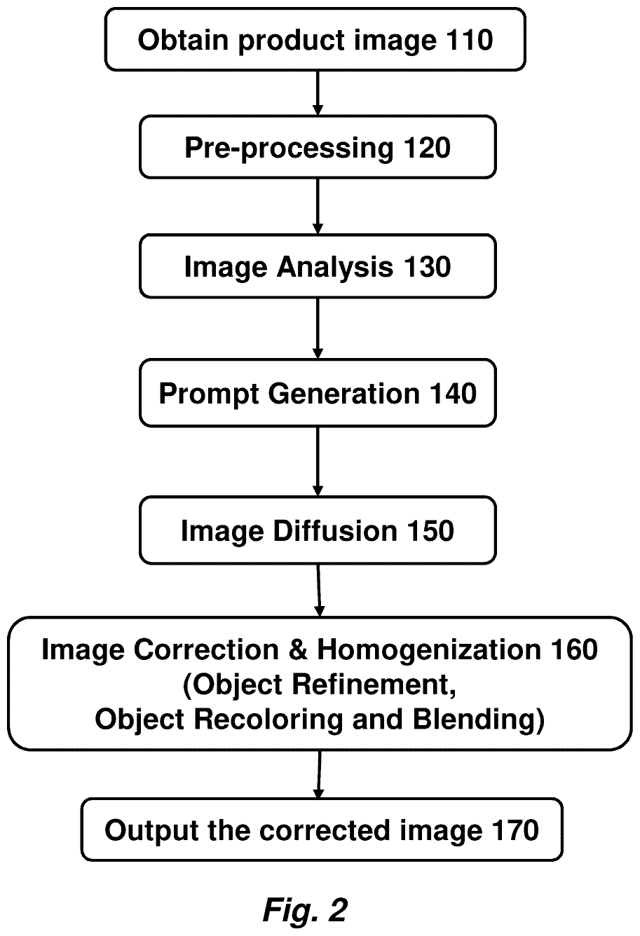

Reference is made to FIG. 2, which is a flow-chart demonstrating an automated method in accordance with some demonstrative embodiments. For example, the method obtains (e.g., receives, downloads, copies) an image of a product or an object (block 110). Then, image pre-processing operations are performed (block 120), such as, complete background removal or partial background removal, as well as object refinement. Image analysis is performed (block 130), to extract useful features and properties that would later be utilized by the automated method; such as, measures, relative dimensions, absolute dimensions, materials from which the object is formed (e.g., wood, metal, plastic), product category (e.g., food item, toy, clothes, furniture).

The method proceeds to generate a detailed textual prompt (block 140), by combining or concatenating prompts or prompt-portions or prompt-strings describing the image properties and/or the object attributes and/or optional user instructions. Then, a Generative AI unit performs image diffusion (block 150), to generate a new image from the textual prompt and the background-removed (and refined) image. The result of the generative AI operations is typically an image that has one or more visual distortions/abnormalities/errors, and/or has size-related errors or placement-related errors (e.g., legs of a table are distorted, or slanted, or excessively thick, or excessively thin). Therefore, the method performs an automated step of image correction and modification (block 160) to cure such errors or distortions or visual abnormalities; such as, by replacing the object in the Generative AI outcome with the correct object and at a correct placement (in-image location) and at a correct size and slanting/orientation. In accordance with some embodiments, the operations of block 160 further comprise an automated process to homogenize the scene, or to homogenize one or more visual attributes of the object and the scenery; such as, uniform lighting or lighting effects, uniform “mood” or look-and-feel attributes, matching shades or shadows, or the like. The modified/corrected image is then provided as output (block 170), and can be used for various purposes (e.g., for displaying on a website, for an online catalog, for a printed catalog, for a digital or printed brochure, for a digital or printed advertisement, for sharing with other users, for posting on social networks, or the like).

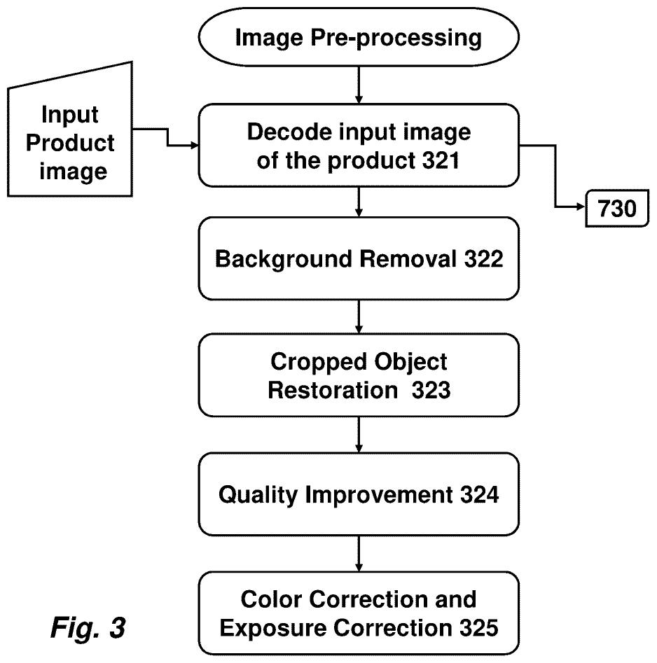

Reference is made to FIG. 3, which is a flow-chart demonstrating a method of the image pre-processing phase, in accordance with some demonstrative embodiments. For example, the original image of the product, typically encoded in an image encoding format (e.g., JPEG, WEBP, PNG, AVIF) is decoded or converted (block 321) into unencoded/uncompressed format (e.g., a bitmap or BMP format), using a suitable image decoding library.

A background removal process is performed (block 322); such as, using AI-based or ML-based image segmentation algorithms, such as an AI-based background removal algorithm that is publicly available from Cloudinary.com and/or using the “Bilateral Reference for High-Resolution Dichotomous Image Segmentation” algorithm/BiRefNet algorithm that is available on GitHub (GitHub.com/ZhengPeng7/BiRefNet); and/or using Segment Anything Model (SAM, or SAM-2) that is available on GitHub and/or from Meta or “Facebook Research” (GitHub.com/facebookresearch/segment-anything), and/or other algorithms that find the salient object in an image and separates the object from the background, thus separating the product in the image from the background and providing a background-removed product image or object image.

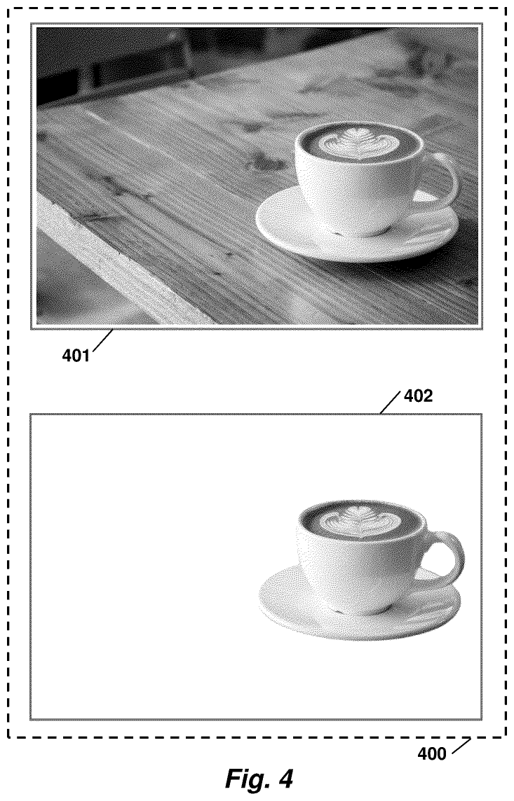

Reference is briefly made now to FIG. 4, which is an illustration of a set 400 of images in accordance with some demonstrative embodiments. Image 401 is an input image of a real-life object. Image 402 is a background-removed version of that real-life object, as generated automatically by the background removal algorithms utilized by some embodiments.

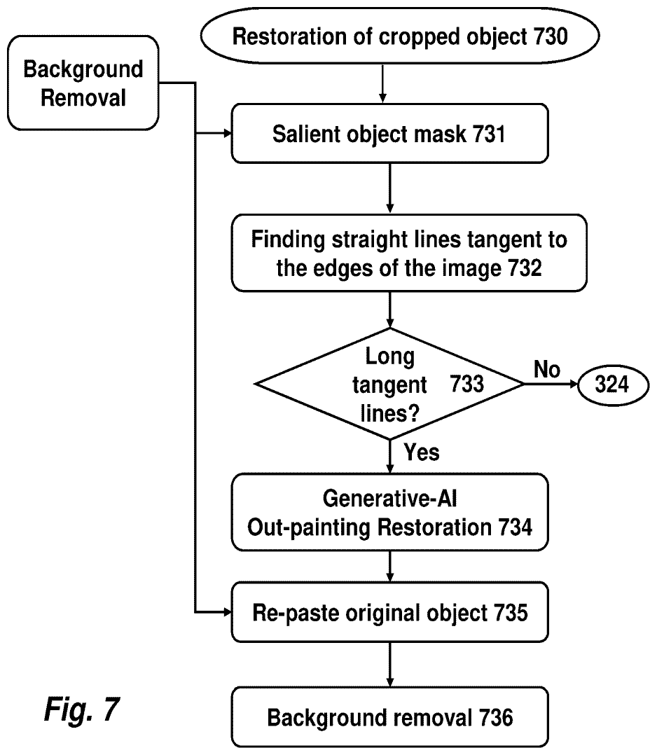

Referring back now to the method of FIG. 3, the method proceeds to perform automated restoration/completion/repair of a cropped object or product (block 323), to improve or restore or complete the depiction of the product in the background-removed image. For example, the method checks whether the product/object in the original/input image is incomplete or has one or more missing or cropped-out areas or features; and if so then the method automatically performs restoration of the incomplete object. A more detailed discussion of the Image Restoration phase will follow below with reference to FIG. 7.

Referring still to FIG. 3, the method proceeds to perform quality improvement (block 324) and visual quality touch-ups and corrections to the input image, and optionally upscaling, prior to scene generation. For example, the method analyses the input image of the product to determine whether it is of low quality (e.g., the input image is grainy, or blurry, or has low resolution), and/or to estimate whether the input image of the product would become degraded through repeated processing and compression. If so, then the method invokes one or more Generative AI image restoration and image improvement algorithms, such as the “gen_restore” or the “e_gen_restore” algorithms that are publicly available from Cloudinary.com, and/or using an upscaling algorithm such as “Stable Diffusion x4 upscaler” available from HuggingFace (huggingface.co/stabilityai/stable-diffusion-x4-upscaler) that utilizes a latent upscaling diffusion model, and/or an upscaling algorithm such as ESRGAN (Enhanced Super-Resolution Generative Adversarial Networks) or other image upscaling algorithm that uses Deep Learning to improve the resolution and detail of images, and/or the Real-ESRGAN algorithm that is available from HuggingFace (huggingface.co/ai-forever/Real-ESRGAN), to increase the quality and/or the visual details of the input image of the product/image.

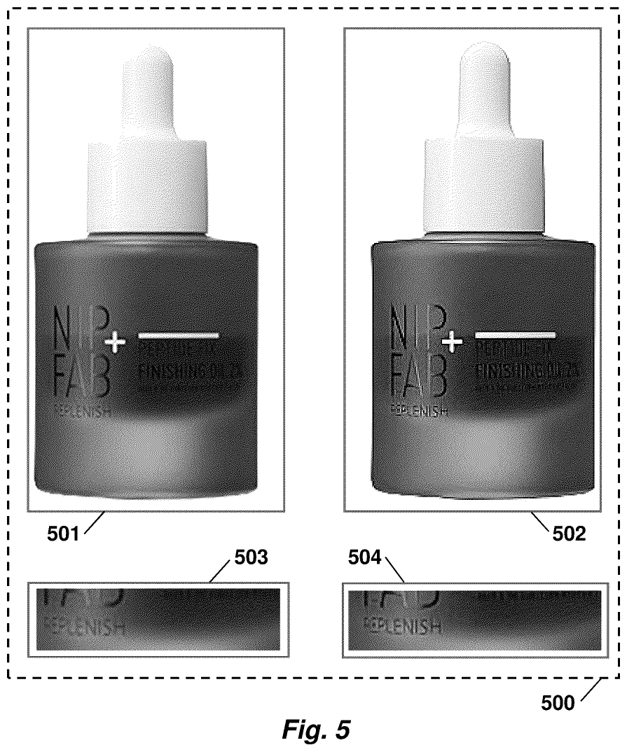

Reference is briefly made now to FIG. 5, which is an illustration of a set 500 of images in accordance with some demonstrative embodiments. Image 501 is an input image of a real-life object. Image 502 shows an enhanced and sharper version of that object after applying the quality improvement step. Similarly, Image 503 is an enlarged portion of the input image of that real-life object, showing that an important label on the product (“Replenish”) is barely visible or barely readable or is partially blurry; whereas, Image 504 is an enlarged portion of the enhanced image of that real-life object, in which that label (“Replenish”) is more visible and more readable and is sharper or less blurry.

Referring back now to the method of FIG. 3, the method proceeds to perform color correction and exposure correction (block 325), by adjusting/modifying the image's colors, contrast and/or brightness to improve its visual appearance and to detect and fix one or more of visual problems. For example, the method may analyze the product image and determine that Exposure Correction is required, to reduce excessive brightness and to reclaim/uncover visual details in over-exposed image-areas and/or by enhancing dim/dark/under-exposed image areas. Additionally or alternatively, the method may analyze the product image and determine that Color Intensification is required, to enrich color vividness, to correct a “washed out” image and make it have a more “dynamic” appearance, and/or to make hues more vibrant and lively. Additionally or alternatively, the method may analyze the product image and determine that Color Temperature Correction is required; such as, by adjusting the white balance, by correcting color casts, and/or by otherwise ensuring that the colors in the image accurately reflect their real-world appearance.

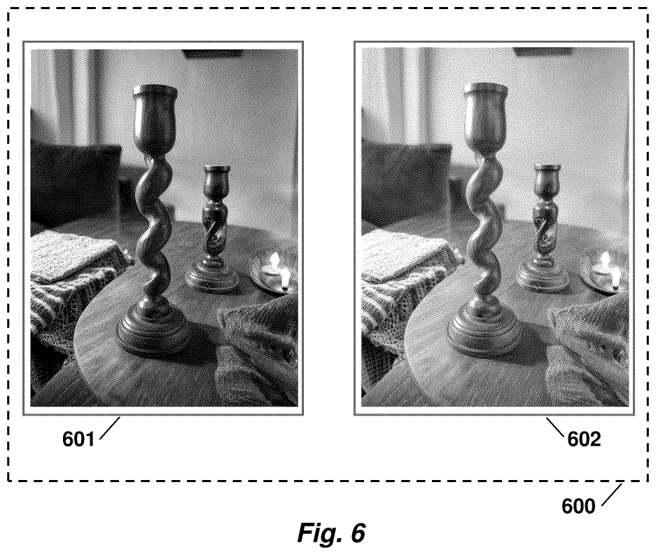

Reference is briefly made now to FIG. 6, which is an illustration of a set 600 of images in accordance with some demonstrative embodiments. Image 601 is an input image of a real-life object. Image 602 is an enhanced image of that real-life object, after applying the color correction and exposure correction in accordance with some embodiments.

Reference is made to FIG. 7, which is a flow-chart demonstrating the process of restoration of missing or cropped-out portions of a product image, in accordance with some demonstrative embodiments.

The process receives an input image, such as the original image or the background-removed image. The process extracts the mask of the salient object (block 731), which is the contour of the background-removed image; and searches for (and identifies) straight lines that are tangent to the edges of the image (block 732).

If a found tangent line is sufficiently long (e.g., it is longer than N percent of the length of the respective image dimension; N can be a pre-defined threshold value, such as 1 or 2 or 3 percent), then the process estimates that the object is indeed cropped out (arrow “Yes”), and continues to restore the cropped object. Otherwise, the method proceeds (arrow “No”) with the operations of block 324 in FIG. 3.

As shown in FIG. 7, the restoration step (block 734) is performed by passing the image to an out-painting process performed by a Generative-AI tool that uses stable diffusion; and by feeding to the Generative-AI tool a suitable prompt guidance describing the whole object and a canvas size that is larger than the original image size (for example, example, 1.5 or 2 times the original image size); and the Generative-AI tool re-generates the missing cropped-out object areas via AI-based out-painting.

The automated process then pastes back the object from the original image (block 735), to avoid any object corruption or object distortion that the Generative-AI process might have added, optionally with suitable blending of the colors or edges of the object; and then repeating the background removal step (e.g., using the background removal algorithm(s) discussed above, such as BiRefNet or SAM) to produce the complete, restored object.

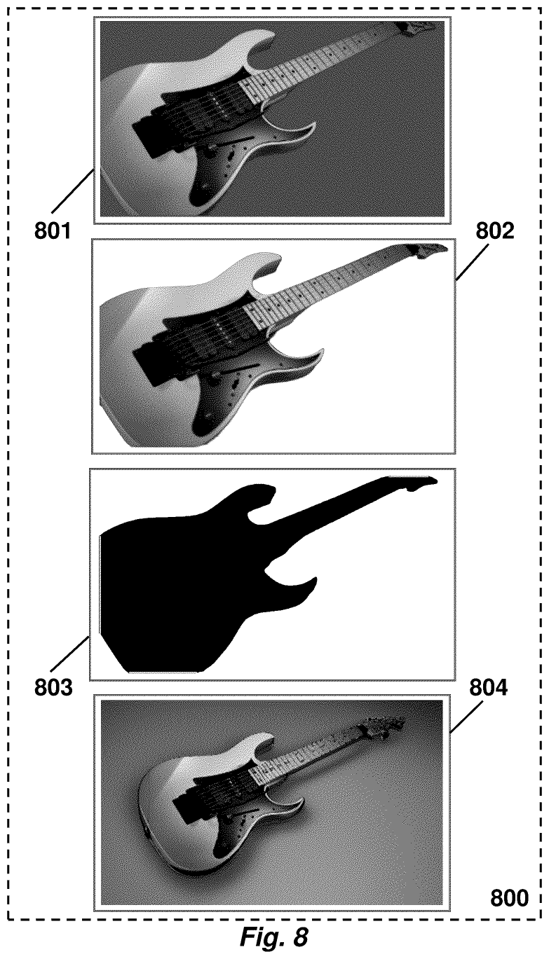

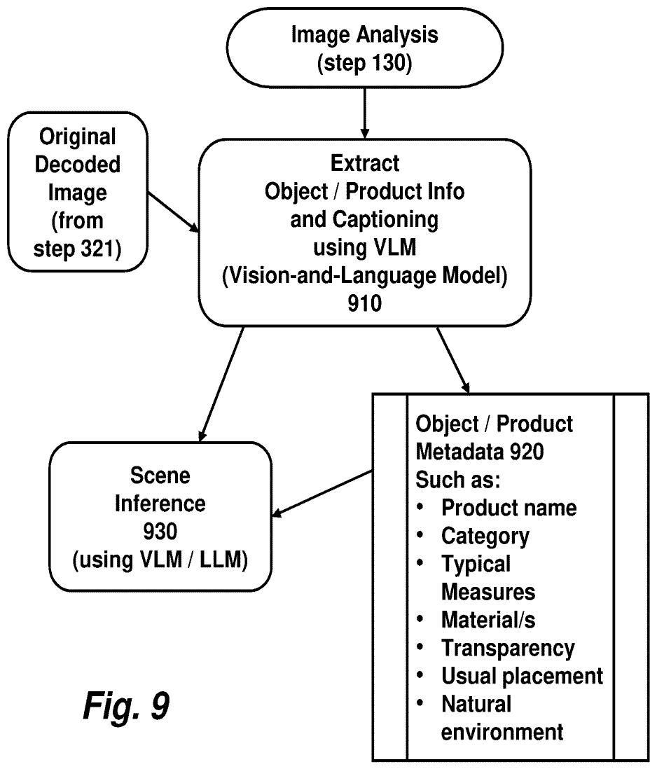

Reference is briefly made now to FIG. 8, which is an illustration of a set 800 of images in accordance with some demonstrative embodiments. It demonstrates the AI-based restoration of a cropped object (e.g., an electric guitar). Image 801 the input image of a real-life object. The object is cropped/cut in three places: left side and lower side of the “guitar body”, and top side of the “guitar neck”. Image 802 shows the background-removed version of this still-cropped/still-cut object. Image 803 shows the object mask, with marking of the contour portions that are tangent to the edges. Image 804 shows the restored object after AI-based out-painting.

Reference is made to FIG. 9, which is a flow-chart demonstrating the process of image analysis (the above-mentioned step 130), in accordance with some demonstrative embodiments.

For example, the original decoded image (from step 231) is received; and is fed into a Vision and Language Model (VLM), or a Language and Vision Model (LVM), or a Language and Image Model, or a Large Multi-Modalities Model (LMM or LMMM) that is capable of processing text as well as images/graphics/photographs/visual content. The VLM extracts objects/product information and captioning (block 910), and generates product/object metadata (block 920).

The VLM can be a Vision and Language Model such as OpenAI ChatGPT 4o that can process both text and images; The VLM is queried or prompted via VQA methods (Visual Question Answering), that query the large model feeding/sending thereto the image and several questions that help identify the object's physical attributes, that are used in later processing steps.

The following table, denoted Table 1, demonstrates fields that can be populated with information by querying the VLM; other or additional fields can be used.

TABLE 1

| Field | Details (examples) |
|---|---|
| Subject | The product name (e.g., Umbrella, Hamburger) |
| Category | The product's commercial category (e.g., |
| | Furniture, Food) |
| Brand | The brand name of the product (e.g., Nike, Toyota) |
| Make | The make or model of the product (e.g., |
| | Air Jordan, Camry) |
| withModel | Does the image contain a person/model/human? |
| subjectHeight | Height of the product itself (e.g., |
| | in inches or centimeters) |
| subjectWidth | Width of the product itself (e.g., |
| | in inches or centimeters) |
| subjectLength | Length of the product itself (e.g., |
| | in inches or centimeters) |
| Type | Type or sub-category (e.g., Armchair and |
| | Barstool are sub-categories of Chair |
| Colors | Main or dominant color(s) of this specific product |
| Placement | The pose or placement of the product (e.g., |
| | Shirt is hanging on Hanger) |
| PlacementType | The type of placement (e.g., hanging; freestanding |
| | on floor; on shelf) |
| NSFW | Is this image or product considered “not safe for work” |
| Style | Is the image a realistic photograph or a |
| | synthetic/graphic designed |
| Shot-Angle | The angle at which the product is depicted (e.g., |
| | eye level; from above) |
| Facing | Where or to which direction the product is facing |

Once the product/object information is extracted by the VLM, that VLM (or another VLM) and/or an LLM are fed the extracted product information, and are prompted to generate proposals for recommended/inferred scenes (block 930) for this specific product and/or for this type of product, and/or to infer the most suitable or relevant scenes or locations in which this product should be photographed for a photoshoot session; and the scene inference information is subsequently passed to the prompt generation process. For example, an inferred scene for a product that is “sliced bread” can be a “kitchen table at home”; whereas, an inferred scene for a product that is “skateboard” can be “outdoor skating playground”.

The scene inference may utilize one or more pre-defined or dynamically-constructed prompts or queries; for example, “Generate a textual description of the top five scenes or surroundings, that a photo-journalist would use to create a magazine advertisement for the product having the attached product information”; or, “Please provide three detailed textual descriptions that you, as an advertisements photographer, can use in order to create an online advertisement for the product having the attached product commercial of a ${object}, please avoid using brand names”

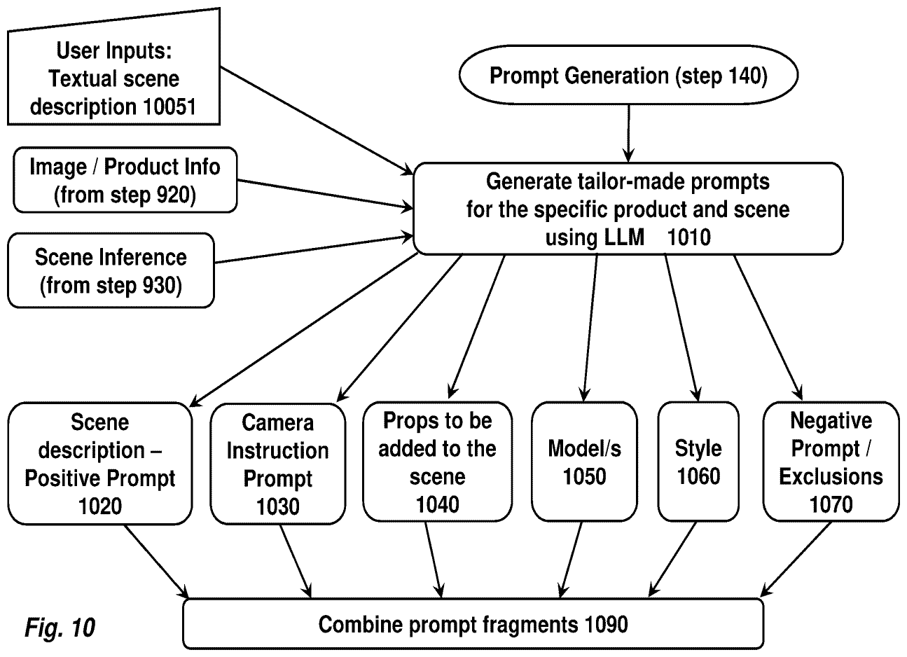

Reference is made to FIG. 10, which is a flow-chart demonstrating the process of prompt generation (the above-mentioned step 140), in accordance with some demonstrative embodiments.

The process receives User Inputs 1005, such as in textual format or by receiving user-selections from a drop-down menu or from a list of options. The user inputs may be a binary selection (e.g., the scene should be crowded or isolated, noisy or calm); a trinary selection (e.g., the scene should express morning time, noon time, night time); a selection from a closed list of options; and/or free-style text that the user may provide in a natural language (e.g., textual description of the scene, expressiveness, particular user-provided guidelines).

The process utilizes the User Inputs 1005, as well as the product information (from step 920) and the scene inference (from step 930), and feeds them into an LLM; and commands the LLM to generate a detailed, textual, tailored-made prompt (block 1010) for this specific product for the purposes of a virtual photo-shoot.

In some embodiments, the LLM is prompted to generate a plurality of prompt-fragments or prompt-segments (e.g., denoted 1020 to 1070), which are then combined or aggregated or concatenated into a combined prompt (block 1090); and the combined prompt that is generated is then passed to the image diffusion process. The LLM can be, for example, OpenAI ChatGPT 4o, or Microsoft Copilot, or Google Gemini, or Meta Llama, or Anthropic Claude, or other Large Language Model or other Large Multi-Modalities Model (LMM or LMMM).

Some embodiments may generate the following demonstrative prompt-fragments or prompt-segments: (a) Scene description—positive prompt (block 1020), describing what should appear in the AI-generated image; (b) Camera instructions (block 1030), sch as indicating the camera shot size (e.g., extreme close up, or shot from two meters distance, or shot from 25 meters away, or wide angle) and/or camera angle (e.g., birds eye view or top-side view, front-side shot, perspective shot, eye level shot); (c) Props or accessories or other items to be added to the AI-generated image (block 1040), such as indicating items or objects that one would typically find in such a location to complement the product (e.g., adding salt and paper dispensers when the product is a pasta dish for placement on a kitchen table); (d) Human model/s (block 1050), indicating whether or not to include in the AI-generated image a human model as part of the scene, optionally including other guidelines about that human model (e.g., male or female; adult or child or teenager or senior citizen; standing or sitting); (e) Style (block 1060), indicating the photography and/or artistic style of the shot that would be AI-generated, such as, lighting guidelines (well lit, dark), camera type, photography or digital art style (e.g., sports style, nature style); (f) Negative prompt guidelines or exclusions or constraints (block 1070), indicating features that should not appear in the AI-generated image (e.g., do not include any other food item; do not draw a table-cloth on the wooden table). In some embodiments, guidelines about features may be expressed in two or more of the prompt segments; for example, to generate a crowded scene (with many elements in it), the prompt may add several Props as part of the positive prompt; whereas, if a clean/calm/isolated location is preferred, then a negative prompt can be added to expressly guide the AI engine accordingly (e.g., “do not add any humans or any other food items except for the pasta dish on the table”).

In a demonstrative example, the product is a Mattress. The system automatically generates the following demonstrative prompt-segments or prompt-fragments:
Prompt-fragments about the Scene:
Style: Architectural design;
Human models: none;
Positive guidelines: Modern Loft, displaying an open, spacious layout, huge windows that allow for plenty of natural light, combining industrial elements with contemporary sleek lines;
Negative guidelines: error, worst quality, low quality, JPEG artifacts, ugly, blurry, bad proportions, gross proportions;
Subject Placement: on the floor;
Shot Size: wide;
Props: side stand, bedroom closet, night lamp.

Prompt-fragments about the Subject (the product):
Subject: mattress;
Category: furniture;
Facing: front;
Style: photograph;
PlacementType: placed;
Placement: on a bed frame;
Type: queen-size bed mattress;
Make: Luxury-305;
Brand: Sleep-Well;
Amount: 1;
SubjectWidth: 190 cm;
SubjectLength: 200 cm;
SubjectHeight: 30 cm;
Colors: black, white;
NSFW: false;
Shot-Angle: eye-level;
With-Human-Model: false.

The generated prompt may be: “Wide Shot photo of a mattress; Modern Loft, displaying an open, spacious layout, huge windows that allow for plenty of natural light, combining industrial elements with contemporary sleek lines in the style of Architectural design”.

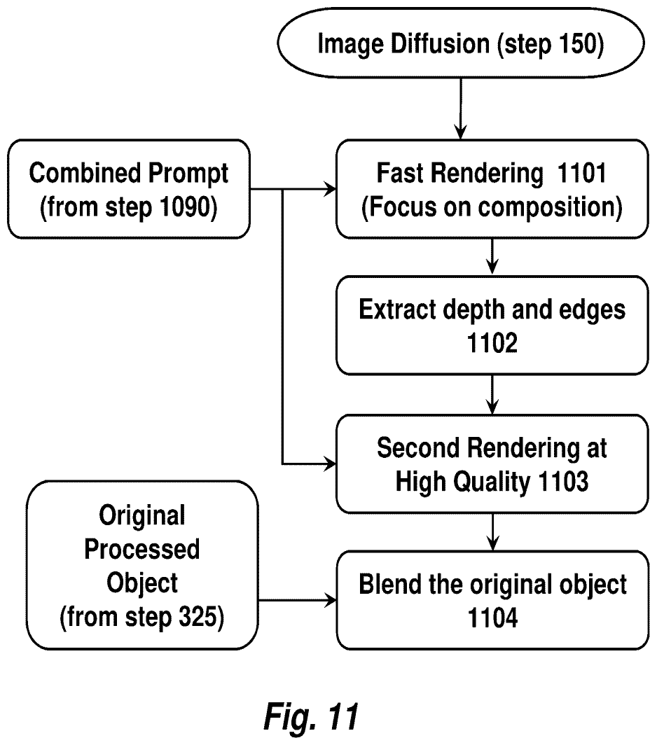

Reference is made to FIG. 11, which is a flow-chart demonstrating the process of image diffusion (the above-mentioned step 150), in accordance with some demonstrative embodiments. This process can be used for AI-generation of a preliminary image, so that a human reviewer (e.g., the customer; the advertisement professional) can provide initial positive or negative feedback. In some embodiments, this process can be used for AI-generation of an actual “final” image that can be used for advertising (e.g., in a magazine, online, in a brochure).

Using the net product image (background removed), and the inference information about the product, the process automatically positions and scales the image on the canvas, and appends the prompt fragments (related to the product and the user settings), and then runs one or more image diffusion sampling cycles.

For example, in a Fast Rendering step (block 1101), the system utilizes an out-painting Generative-AI tool that is configured for Fast (or Fastest) Processing (rather than for Highest Quality) for stable diffusion (SD1.5) model; such as running 4 steps with 0.4 CFG scale (classifier-free guidance scale, a parameter that controls how much the image generation process follows the text prompt; the higher the value, the more the image follows the given text input); and this step returns a low-quality or a “draft” quality, that is then used to construct the scene's general outlines with the correct scale.

The process proceeds to extract depth and edges (block 1102) from the low-quality image; and to pass this information to a second Generative-AI rendering engine, with the additional information operating as hints or guidelines to the second rendering, that is run at higher quality settings, to generate a good-quality AI-generated image.

The process then performs high quality rendering (block 1103), using high quality settings and hints from step 1102, to render a high-quality image.

Finally, the process blends the original product (block 1104); since the diffusion process is lossy and can corrupt or distort the original product, the system automatically pastes the original product (in its enhanced version) back on the diffusion-generated image.

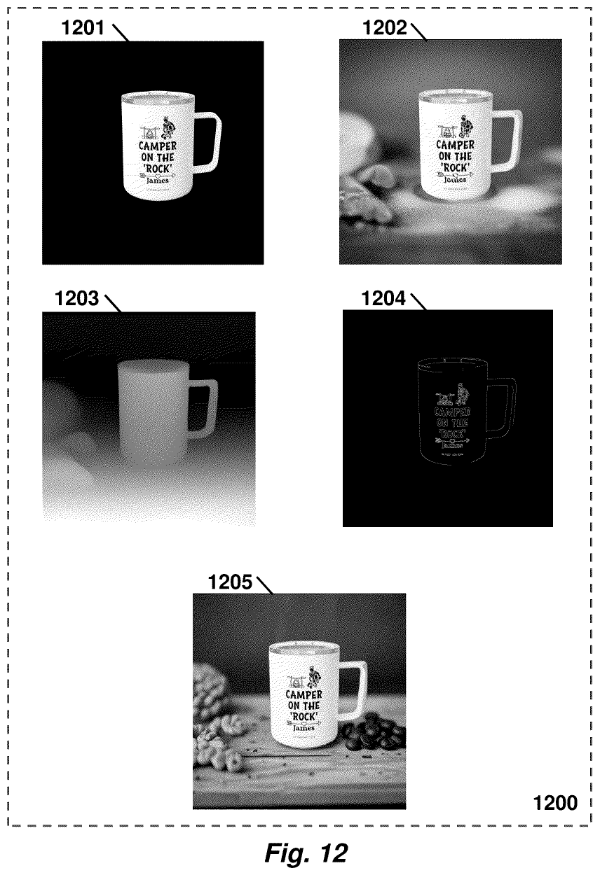

Reference is made to FIG. 12, which is an illustration of a set 1200 of images, produced and utilized in the image diffusion process, in accordance with some demonstrative embodiments. Image 1201 is the “net version”/background-removed version of the product. Image 1202 shows the result of a low-quality AI-generated scene rendering that was produced via fast rendering. Image 1203 shows extraction of the depth map. Image 1204 shows extraction of the object's edges or contour. Image 1205 shows the high-quality result using a second-pass, high-quality, Generative-AI rendering with an overlay or pasting of the original object.

Referring back to FIG. 2, step 160 includes Image Correction & Homogenization, which may be performed by (a) Object Refinement, and (b) Object Recoloring and Blending.

The refinement operations may include, for example, applying an image refinement pass on the product mask, to increase and improve edge blending capabilities for more natural blending of the product with the surrounding region. For example, a Plain Vision Transformer may be applied, such as “ViTMatte—Boosting Image Matting with Pretrained Plain Vision Transformers”, available from GitHub (GitHub.com/hustvl/ViTMatte).

Then, object recoloring and blending operations are performed: the system automatically matches the color and lighting attributes of the original object to those created by the Generative-AI process. This can be performed using libraries such as “color-matcher”, available from GitHub (GitHub.com/hahnec/color-matcher) or other suitable tool that takes a color reference image and a target image and applies a color grading to the target image that matches the reference colors.

For demonstrative purposes, portions of the discussion above described a Generative-AI process of a real-life product/object virtual photo-shoot; however, some embodiments may be similarly configured to yield AI-Generated photoshoots in which the “object” is a human, based on a photograph of that human. Similarly, some embodiments may be similarly configured to yield AI-Generated photoshoots in which the “object” is a computerized image of a human, or a computerized image of a virtual/fictional character (e.g., a dragon; or Donald Duck), or a computer-generated image of an object or a product (and not necessarily a photograph of that product or object; such as, a human artist's digital painting of a product or an object; or a synthetic/computer-generated image of that product or object).

For demonstrative purposes, portions of the discussion above described a Generative-AI process of a product/object virtual photo-shoot, such that an actual photograph of a real-world object is placed virtually within an AI-generated surrounding or background. However, some embodiments may provide a “reversed” process, in which an actual photograph of a real-world venue (e.g., room, bedroom, living room, apartment, house, home, residence, office) is utilized as the base/input photograph, and it is virtually “staged” using Generative-AI to further included added-in props or accessories or products/objects, that are properly blended-in and automatically homogenized within their surroundings.

For example, a real-estate agent or broker or owner may use a camera to capture real-world photographs of rooms in a house; and a Generative-AI process may then add products or objects into those photographs, such as, virtually adding a flower vase on a table, virtually adding a standing lamp in the corner of the bedroom, virtually adding a coffee-table into the living room, adding a salt-and-pepper pair onto the kitchen counter, and so forth. The Generative-AI enhanced photographs can then be used by the agent/broker/owner to showcase the house (or other venue) that is intended for sale or rent. Some embodiments may thus provide a system and an automated method for virtual room staging or virtual home staging, with an automated process of preparing and decorating a home for sale/for rent to make it more appealing to potential buyers or tenants.

The Applicant has realized that a real-world Room Staging/House Staging process is costly, time-consuming, and/or effort-consuming; as it requires manual procurement and placement of real-life decorative objects, that can be expensive or fragile or heavy or hard-to-find. In contrast, realized the Applicant, the virtual home staging assisted by Generative AI can be harnessed to generate alternative or enhanced visual content faster and cheaper than physical staging or three-dimensional modeling, in an efficient and fast and automated/semi-automated computerized process.

In a demonstrative implementation, the Virtual Home Staging system receives as input an image (e.g., a real-world photograph) of a room or other venue. The system analyzes the input image, and automatically generates textual prompt(s) indicating which areas or image-portions to keep or maintain unchanged (e.g., “Please keep the ceiling and the hardwood floor unchanged”), and further automatically generates textual prompts indicating which products/objects/modifications to introduce to that image using Generative-AI (e.g., “Please add a standing lamp in the far-right corner of the living room”, or “Please add a pair of salt-and-pepper dispensers on the kitchen counter”) and/or prompts indicating otherwise which modifications and enhancements to perform (e.g., “Please add into the empty dining room a dining table set for a meal and four chairs around it”).

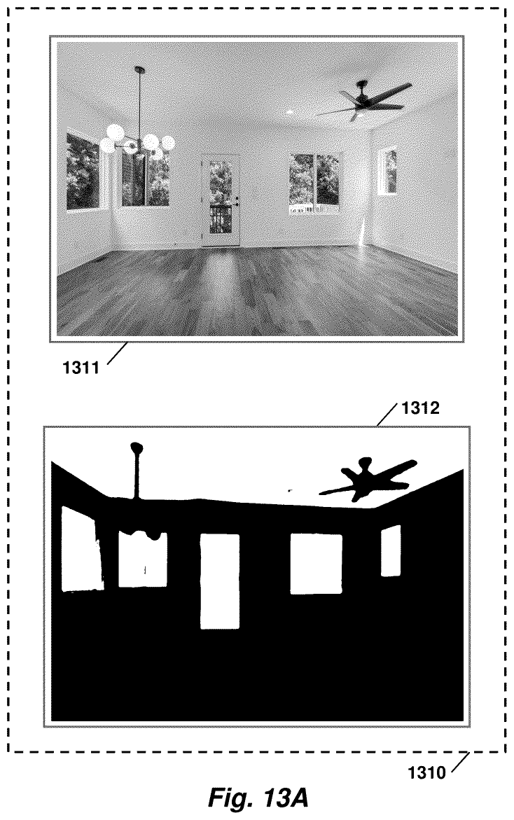

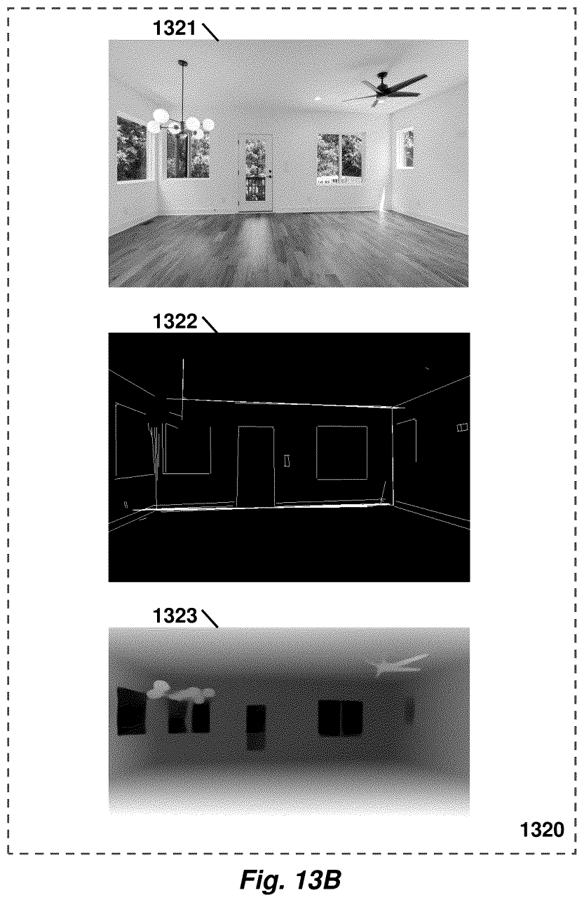

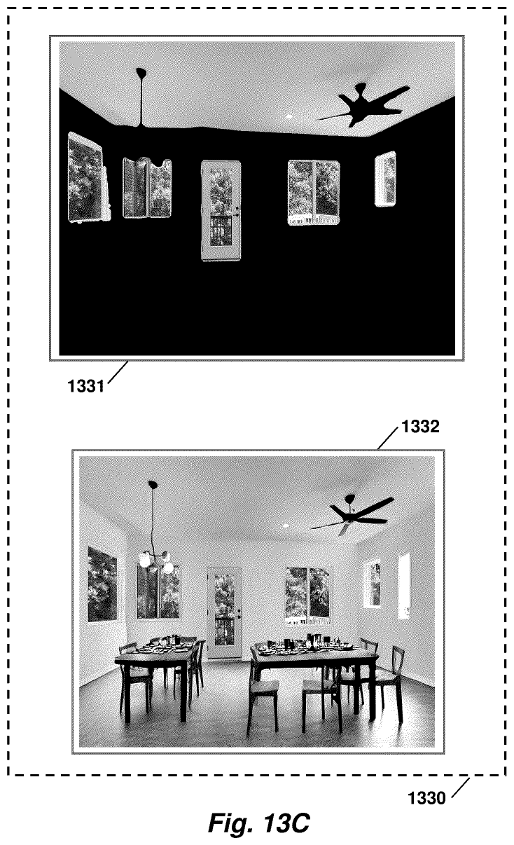

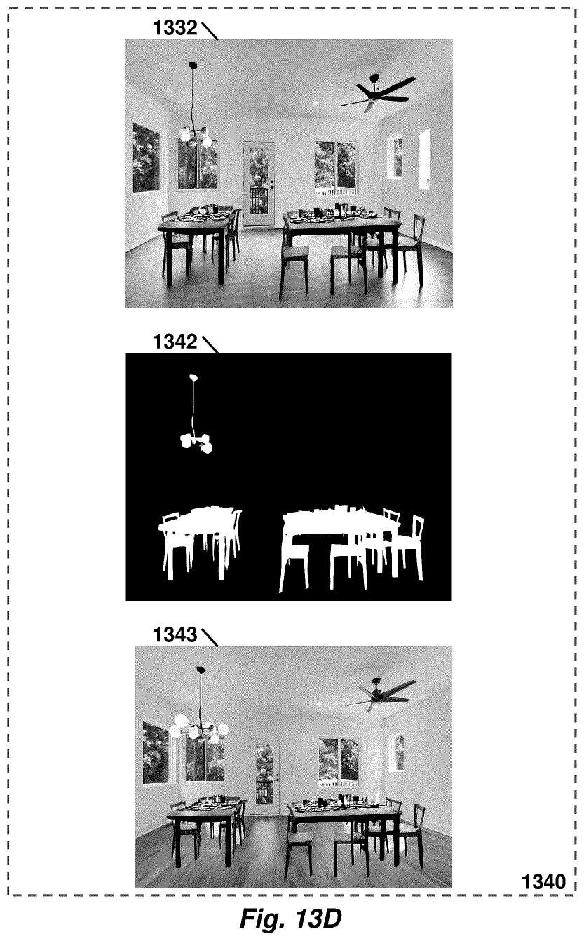

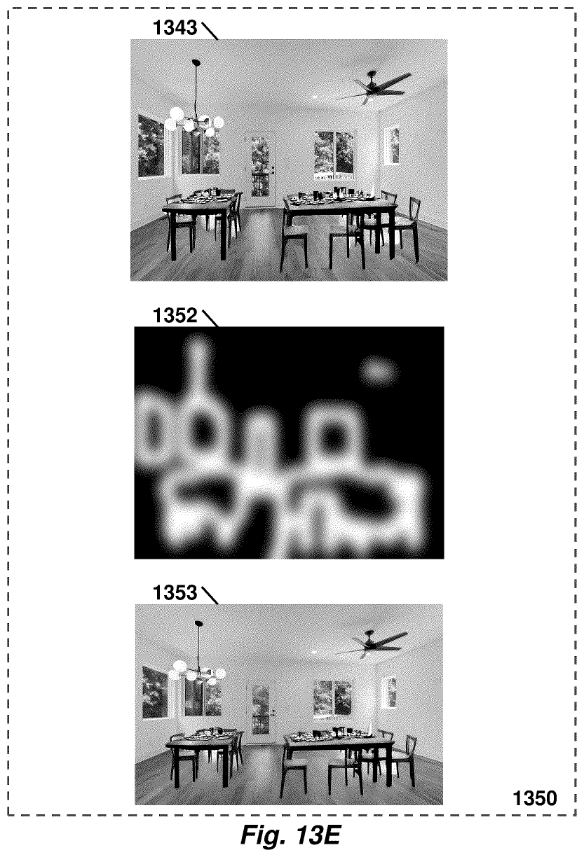

Reference is made to FIG. 13A, which is an illustration of a set 1310 of images in accordance with some demonstrative embodiments. Image 1311 is an input image, such as a photograph of a real-life generally-empty room. A textual prompt may instruct the system to generate a Painting Mask while keeping/maintaining particular image-regions or image-features (e.g., “Keep floor, ceiling, door, windows”), and Image 1312 shows the generated Painting Mask.

Reference is made to FIG. 13B, which is an illustration of a set 1320 of images in accordance with some demonstrative embodiments. Image 1321 is the input image described above.

Reference is made to FIG. 13B, which is an illustration of a set 1320 of images in accordance with some demonstrative embodiments. Image 1321 is an input image, such as a photograph of a real-life generally-empty room. ControlNet guidance images are generated, as they may assist the system in correctly keeping the structure of the room (or venue) as it is being further processed with Generative AI. For example, Image 1322 shows an M-LSD version or an M-LSD transformation (Mobile LSD, or Mobile Line Segment Detection) of the input image; obtained by applying an LSD or M-LSD transformer, such as those available on HuggingFace (e.g., HuggingFace.co/lllyasviel/sd-controlnet-mlsd). Image 1323 shows a Depth version or a Depth transformation of the input image; for example, shown as grayscale with darker regions being “farther” or “deeper” in space relative to the observer, and with lighter regions being “closer” to the observer.

Reference is made to FIG. 13C, which is an illustration of a set 1330 of images in accordance with some demonstrative embodiments. As shown, the system generates an Inpaint version or an Inpaint Image 1331, in which black image-regions would indicate to the Generative AI the areas in which it is permitted/intended to add new visual features, whereas non-black regions would indicate to the Generative AI the areas that should not be modified or touched or obstructed with new visual features. The Inpaint Image 1331, as well as the Painting Mask Image 1312, the M-LSD Image 1321, and the Depth Image 1322, are fed into the Generative-AI unit (e.g., an image diffusion unit) together with a textual prompt, such as, “Please generate a realistically-looking image of a large dining room having two dining tables that are set for a meal, with dining chairs”. It is noted that in accordance with some embodiments, at this stage in the process, the original input image 1311 is not fed into the Generative AI tool; rather, it relies on the masked versions or the transformed versions, and on the textual prompt. The Generative-AI unit generates the demonstrative Gen-AI Image 1332.

Reference is made to FIG. 13D, which is an illustration of a set 1340 of images in accordance with some demonstrative embodiments. The Gen-AI image 1332 is shown initially in this set of images. A foreground detection or foreground identification process is performed, to yield a Foreground Mask 1342. Then, an image blending process performs the blending of the original features of the room from the input image 1311, into the Gen-AI image 1342, by taking into account the Foreground Mask 1342, to thereby generate the Blended Image 1343. Importantly, it can be observed that while the Gen-AI image 1341 has a “generic” type of hardwood floors that are smooth, the Blended image 1343 has those hardwood floors replaced back with the actual real-life hardwood floors that appear in the original input image 1311. This important and innovative process allows the real-estate broker/agent/owner to efficiently generate a virtually-stated image, that is still faithful to real-life attributes and real-life features of the original input image and the original real-world venue/room.

Reference is made to FIG. 13E, which is an illustration of a set 1350 of images in accordance with some demonstrative embodiments. The Gen Blended Image 1343 is shown initially in this set. An Inpaint Mask 1352 is generated; and a Refined Blending is performed using light inpainting on edges of items, to yield the Refined Blended Image 1353.

It is noted that the Generative-AI Virtual Staging process that is described above, can be utilized in a variety of other scenarios, and is not limited to the use-case of staging a home towards selling it or leasing it. For example, an architect or an internal decorator may utilize the Virtual Staging system to demonstrate to a client how rooms or modified rooms would look like; a theater stage manager may utilize the Virtual Staging system to prepare one or more visual staging options for an upcoming theater play or show; a consumer may use the Virtual Staging system to re-imagine how a particular room in his home would look if he places there various types of furniture items or accessories; and so forth.

Some embodiments may be implemented as a stand-alone web browser (e.g., similar to Google Chrome or Microsoft Edge or Apple Safari or Mozilla Firefox), or as a stand-alone image browsing program or software or unit (e.g., similar to IrfanView), or as a stand-alone social network/social media client-side program (e.g., Instagram, Tiktok, Pinterest), or as an extension or add-on or plug-in to an image editing or photo editing program (e.g., similar to Adobe Photoshop or GIMP) or as an extension or add-on or plug-in to such browser or program. For example, a web browser may be configured or constructed, or may be expanded or extended via such plug-in or add-on, to enable an end-user who is browsing the Internet and/or is browsing an image gallery on his device, to select or to right-click a particular image of a product (e.g., in an e-commerce website or in an online store), and to command that browser with one click or one tap “Please generate a virtual photoshoot for this product”; and the automated process is invoked and performed automatically, and one or more Generative-AI synthetic images are generated via Image Diffusion, and can be automatically saved or stored (locally and/or on a remote server), shared with third-parties, or otherwise utilized. Some embodiments may thus optionally provide an innovative solution, that enables an end-user to browse the Internet, see a product that he likes to purchase or to resell, and immediately command the web browser to generate a Virtual Product Photoshoot from it; or allows the end-user to utilize a photograph editing program (e.g., Photoshop or GIMP), and to immediately command that program to generate a Virtual Product Photoshoot from it; or allows the end-user to browse products or videos on Instagram/Pinterest/Tiktok/Facebook/other social networking website or platform or application, select a photo or a video of a product, and to immediately command that program to generate a Virtual Product Photoshoot from that user-selected image or from a Video Frame that the system extracts automatically from that user-selected video; or allows the end-user to utilize an image browsing program (e.g., a “Gallery” app on a smartphone, IrfanView on a laptop computer), and to immediately command that program to generate a Virtual Product Photoshoot from it; and so forth.

Some embodiments provide a system and a method configured to automate the creation of product photoshoots by seamlessly blending real-life images with AI-generated backgrounds or components. The system simplifies and/or expedites the traditionally slow and labor-intensive process of producing high-quality photoshoots for marketing, product catalogs, and advertising. The system combines photographs of physical objects with AI-generated backgrounds, scenes, or additional visual elements, aiming to eliminate visible inconsistencies between real and synthetic components. The system is able to generate images that appear authentic, minimizing visual clues that could reveal the use of artificial elements.

The Applicant has realized that traditional photoshoots require detailed planning, involving equipment setup, studio arrangements, props, models, lighting, and extensive post-processing. This process can be costly, time-consuming, and prone to logistical challenges. Moreover, alterations or corrections during post-production can further increase expenses and delay the final product. Recognizing these limitations, the proposed system aims to offer an efficient, cost-effective solution that maintains visual fidelity while enabling greater creative flexibility.

The system allows users to input a single photograph of a product or object along with an optional textual description or prompt specifying the desired scene. Leveraging generative AI, the system autonomously creates the required background or environment and integrates the object into it. The process ensures that the composed image looks natural, with no obvious signs of stitching between real and AI-generated portions.

The system can be configured to automatically perform several tasks, including: (a) Background Removal and Object Refinement, as the system extracts the product or object from its original photograph, removing unnecessary background elements. This step uses advanced AI segmentation algorithms like BiRefNet or Segment Anything Model (SAM) to ensure clean separation of the object. (b) Creation and utilization of AI-Generated Scenery, based on the user's prompt and/or system-inferred details, as the system generates a new background or surrounding for the object or product. This background may extend the product's features (such as lighting or shadows) into the scene via refined blending, ensuring visual coherence. (c) Error and Distortion Detection and Correction, as the system can identify and correct visual inconsistencies, such as incorrect object placement, incorrect proportions, abnormal visual features, or distortions. If any errors are found (e.g., a table appears floating), the system adjusts the size, orientation, and/or position of the object. (d) Lighting and Shade Homogenization, as the system aims to achieve a realistic appearance, and applies uniform lighting effects and adjusts shadows to match both the real object and the AI-generated elements.

In some embodiments, an automated workflow may include the following steps. (a) Input Phase, in which the user provides a product photograph and may input text-based scene descriptions. (b) Pre-Processing, in which the system removes the background from the product image, detects any incomplete parts, and restores missing portions using AI-based out-painting techniques. (c) Scene Generation, in which the system uses the refined product image, and creates a composite image by embedding the background-removed product into an AI-generated background or scenery. (d) Image Quality Enhancement, using algorithms such as ESRGAN, to enhance the resolution and correct exposure, color, and lighting. (e) Generating the final output, as the system produces a realistic composite image in which the original product is suitably blended within the AI-generated scenery; the final image can be used for online catalogs, offline catalogs, brochures, advertisements, social media posts, or other purposes.

While some portions of the discussion above may primarily focus on product photography, the system has a variety of other potential applications, such as: (a) E-Commerce platforms, as the system can automatically generate product images for online stores. (b) Advertising and Marketing, as the system can create engaging advertisements without the need for physical props and complex real-world setups. (c) Real Estate, and particularly virtually staging rooms or homes by adding furniture or decorative elements to real photographs of generally-empty spaces or mostly-empty rooms or partially-empty rooms. (d) Personalized Media, as the system may enable a user to integrate user-provided objects into an AI-generated setting, such as custom holiday cards or social media visuals.

Some embodiments may thus provide the following attributes to the workflow of product shooting or home staging. (a) Efficiency, as the system reduces the time and effort required to produce high-quality images. (b) Cost-Effective workflow, as the system eliminates the need for complex setups, studio rentals, and extensive post-production work. (c) Creative Flexibility, as the system enables endless customization by altering scenes through text prompts without needing to reshoot products. (d) Error Prevention/Mitigation, as the system can automatically detect and correct visual flaws, ensuring high-quality outputs with minimal human intervention.

Some embodiments may provide one, or some, or most, or all, of the following features or advantages. (1) AI-based Background or Scenery Generation, as the system uses generative AI to create customized backgrounds or scenes, blending real-world product images with synthetic elements for seamless integration, ensuring no visible transitions between real and AI-generated components. (2) Automated Background Removal from products and objects, using advanced segmentation models like BiRefNet and SAM; the system precisely isolates objects from their backgrounds, ensuring clean extractions without manual intervention, essential for high-quality product images. (3) Inpainting and/or Outpainting for missing/cut-off object portions, if parts of an object are cropped or incomplete; the system automatically restores them through inpainting and/or outpainting techniques, generating the missing details with AI, ensuring the product appears intact in the final image. (4) Error Detection and Visual Correction, as the system identifies distortions or placement errors (e.g., floating objects) and automatically adjusts size, orientation, and position to ensure visual accuracy within the composite image. (5) Lighting and Shade Harmonization, as the system applies consistent lighting and shadow effects to both real and AI-generated parts, blending them naturally and achieving a unified visual appearance, regardless of original lighting conditions. (6) Optionally, providing the ability to support Real-Time Prompt-Based Customization, as the user can modify backgrounds and scenes through text prompts, instantly generating new composite images without reshooting or additional post-processing efforts, offering creative flexibility. (7) Adaptive Quality Enhancement, using algorithms like ESRGAN and Stable Diffusion, as the system improves the resolution and visual clarity of input images, addressing issues such as blur, graininess, and low resolution effectively. (8) Process for AI-Driven Virtual Room Staging, as the system can use real photographs of spaces, such as empty rooms, and add virtual furniture and props through generative AI. (9) Pre-Generated Scene Suggestions, by analyzing product properties; the system can generate scene recommendations or proposals (e.g., proposing to place a loaf of bread on an empty kitchen counter), guiding users with context-relevant ideas for visually appealing compositions. (10) Modular Image Assembly Workflow, as composite images are generated step-by-step, allowing individual components (e.g., products, backgrounds, props, effects) to be adjusted independently, facilitating precise visual customization. (11) Multi-Pass Rendering for High-Quality Outputs, as the system leverages a dual-pass (or multiple-passes) rendering process, starting with a draft generation followed by high-quality refinement, to deliver detailed and accurate images that meet professional standards. (12) Blended Object Overlay, that prevents or cures object corruption by AI rendering; the original product image is re-inserted into the final output with refined edges, and with particular adjustments (e.g., cropping, re-sizing, re-orienting) to ensure that the object remains undistorted and true-to-life. (13) Optionally, the system may offer Dynamic Lighting Simulation, as the system can generate virtual lighting setups to simulate different moods or environments, such as daylight or soft evening lighting, enhancing the versatility of product images. (14) Depth Mapping and Alignment, as the system generates and then employs depth maps and edge detection maps to ensure that objects align correctly and naturally within their AI-generated environments, avoiding misplacements like uneven surfaces or tilted products. (15) End-to-End Automation for Fast Turnaround, from input to output, as the system automates every step of the image creation process (e.g., background removal, enhancement, scene generation, error correction), reducing human effort and human-based errors and speeding up production timelines.

Some embodiments may provide one or more, or most, or all, of the following surprising or non-obvious or counter-intuitive features: (1) “Reverse” Virtual Staging, such that instead of generating images of real-life products within AI-generated environments, the system allows real-world scenes, such as rooms or homes, to remain the primary focus while adding virtual props or accessories. (2) Text-Generated Scene Inference, as the system can autonomously recommend suitable scenes for products by analyzing object attributes; thereby predicting ideal or suitable environments without manual input, such as proposing outdoor settings for lifestyle items. (3) Error-Correcting/Self-Correcting AI Feedback Loop, such that even after generating an image with AI-generated components and with photograph-based components, the system autonomously performs a feedback loop, detecting and correcting visual abnormalities or distortions (e.g., slanted/distorted table legs; plate floating in mid-air), ensuring flawless outputs through iterative AI adjustments. (4) Virtual Object Completion/Restoration, as the system can restore or re-construct or re-build cropped or missing parts of products, leveraging AI to generate missing object-portions, making the final object appear whole even if it was initially incomplete or partially cut-out or partially hidden; such as, virtual object restoration through Out-Painting, as the system can recreate missing edges or portions of objects by out-painting, counter-intuitively expanding a limited input to generate complete, visually coherent objects from partial data. (5) Dual-Pass Image Diffusion for efficiency (rapid processing) and accuracy, as a first draft image is quickly generated via AI to determine outlines, and it is then followed by high-quality rendering using feedback from the first pass, thereby balancing speed and precision. (6) Dynamic Prompt Segmentation, as the system's AI unit can break user prompts into smaller components (e.g., lighting, human presence, product placement), creating highly customized scenes while maintaining the structure and coherence of the user's input. (7) Foreground Mask Blending, as the system can blend products seamlessly by using a foreground mask that aligns AI-generated components with original image features, preserving important product attributes even in complex AI-generated environments or scenes or backgrounds. (8) Generative AI-Assisted Lighting Adjustment, as the system can simulate or emulate lighting conditions, enhancing the realism of the composite beyond what the original photo captured. (9) Seamless Multi-Model or Multi-Modal Integration, as the system can innovatively combine several AI models or tools, such as textual analysis via LLM, visual analysis via VLM or LMMM, background removal, image diffusion, image upscaling, and/or other AI-based processes, into a cohesive system that delivers better results than using any individual tool on its own.

In some embodiments, the system may include some or most or all of the following logical units, which may be implemented using hardware components and/or software components. (1) A processing unit (e.g., CPU, DSP, processor, processing core, controller, logic unit) configured to handle computing tasks, manage workflows, and coordinate between hardware units and software modules required for the AI-driven photoshoot system. (2) A Graphics Processing Unit (GPU), for running resource-intensive Generative AI models, ensuring smooth rendering of backgrounds, textures, and images at high speed and precision. (3) Memory Units (e.g., RAM, volatile memory unit, Flash memory) to store temporary data for active processes, facilitating fast computations for image generation, background removal, and error correction. (4) Long-term Storage Units (e.g., hard disk drive (HDD), solid state drive (SSD), or the like), to store draft versions or final outputs for further utilization, and/or to store input images, AI models, system logs, and output data, ensuring rapid data access during operations. (5) Optionally, an AI Model Repository or Hub, such as a library of pre-trained/fine-tuned Generative AI models, segmentation tools, and enhancement algorithms such as BiRefNet, SAM, and ESRGAN, supporting the various AI operations, as well as an interface to a local or a remote LLM/VLM/LMMM. (6) A Generative AI engine or unit, which is a core unit that synthesizes virtual scenes and environments, processes user prompts, and integrates objects into AI-generated backgrounds. (7) Image Segmentation Module, which is an AI-based module that isolates objects from their backgrounds, ensuring precise extraction of the product image for seamless integration. (8) Background Removal Unit, that utilizes segmentation algorithms to completely or partially remove backgrounds from photographs, leaving only the desired objects intact. (9) Object Detection Unit, that identifies key features, dimensions, and physical characteristics of the product to facilitate accurate placement within AI-generated environments. (10) Scene Recommendation Unit, such as an AI-powered tool that analyzes product attributes and suggests (via a VLM/LLM/LMMM) ideal or suitable scenes for the photoshoot based on product type and commercial relevance. (11) Text Prompt Generator Unit, that automatically constructs detailed textual descriptions from product metadata and user inputs to guide scene generation and object placement. (12) Image Enhancement Unit, that enhances the clarity, sharpness, and/or resolution of input images using algorithms like Real-ESRGAN to ensure high-quality results. (13) Lighting Simulation Unit, that simulates virtual lighting conditions to ensure visual consistency between the real object and the AI-generated background. (14) Object Restoration Unit, that utilizes out-painting and/or in-painting algorithms to restore missing or cropped sections of objects, ensuring object completeness in final images. (15) Edge Detection Unit, that analyzes and finds the edges of objects to ensure smooth blending and alignment within AI-generated scenes. (16) Depth Mapping Unit, that creates a depth map for objects and scenes to assist with proper placement and scaling within virtual environments. (17) Foreground Mask Generator Unit, that generates masks that isolate objects from AI-generated scenes, ensuring that original features are preserved and enhanced. (18) Image Blending Unit, that combines objects and backgrounds into a unified image, matching lighting, shadows, and colors for seamless visual integration. (19) Visual Error Detection and Correction Unit, that automatically identifies and fixes distortions or placement errors, ensuring that objects appear natural and correctly aligned. (20) A local or remote Vision and Language Model (VLM), or other large multi-modal model (LMMM) that processes both images and text to extract product attributes and support visual question answering. (21) A User Interface, such as a front-end interface that allows users to upload images, input prompts, and review generated outputs in real-time. (22) Communication units and interface, that ensure data exchange between the AI components and the user interface, synchronizing workflows across the system. (23) Wired and/or wireless transceivers, or other communication unit(s) that connect the system to cloud-based services, enabling access to external or remote or cloud-based AI models and computational resources. (24) Automated Workflow Engine, that controls and orchestrates the sequential operations of the system, ensuring the correct flow of data and timely execution of processes. (25) Textual Prompt Generator, that automatically creates detailed scene descriptions from product metadata and user inputs, optimizing the AI's ability to generate accurate visuals. (26) Multi-Pass Image Diffusion Unit, that uses a two-step rendering approach: quick initial rendering for layout verification, followed by high-quality rendering for final output. (27) Image Quality Enhancement Unit, that applies AI-based algorithms to sharpen, denoise, and upscale product images, ensuring they meet professional visual standards. (28) Object Placement Validator/Corrector Unit, that checks and verifies that objects are positioned correctly in AI-generated scenes, preventing them from appearing to float or intersect unnaturally, and optionally invoking a corrective process to move/relocate/resize/replace/tilt/slant/blend the object correctly into the AI-generated scene. (29) Color Matching and Blending Unit, that matches the color tones of real objects with their virtual environments, ensuring visual coherence across all elements in the image. (30) Visual Attribute Harmonizer Unit, that is configured to balance textures, shadows, and lighting across the object and background, creating a unified and natural appearance. (31) An Object Detection and Classification Unit, that identifies or determines the product type, dimensions, and material properties, providing data to guide scene selection and rendering. (32) Generative Out-painting Unit, that extends object features or environments beyond the original boundaries, enabling enhanced visual compositions through AI-generated expansions. (33) Automated Product Metadata Extractor, that analyzes product images to generate detailed metadata (e.g., size, color, type) that guides the scene generation process. (34) Virtual Props/Accessories Generator Unit, that creates and adds AI-generated accessories or props to scenes, complementing the main object and enriching the visual context. (35) Visual Question Answering (VQA) Unit, that can process queries about the product or scene to refine the AI-generated output based on user preferences or corrections. (36) Adaptive Scene Styling Unit, that adjusts the artistic style of the generated scene (e.g., minimalist, industrial) based on user inputs or inferred product aesthetics. (37) Content-Aware Image Blending Unit, configured to performing in-image blending operations and visual corrections to ensure that product features blend naturally with virtual elements by adjusting textures and patterns across all components and/or by refining edges of components within the image. (38) Virtual Staging Unit, that automates the AI-based creation and placement of virtual furniture or accessories or decorative items within real-world images of rooms or houses or other venues. (39) High-Fidelity Image Review Interface, that enables users to inspect, adjust, and approve AI-generated visuals, providing zoom and layer control for precise edits. (40) Adaptive Perspective Correction Unit, that adjusts the angle or slanting or angular tilt or orientation of objects in relation to the generated scene, ensuring accurate perspectives to avoid visual inconsistencies. (41) Semantic Segmentation Unit, that differentiates between fine-grained elements within images, such as distinguishing between overlapping objects, for precise editing and placement. (42) Visual Consistency Validator/Corrector Unit, that scans or analyzes the final composite image for mismatches in textures, lighting, or colors, automatically identifying areas that need correction or further blending/refinement/harmonization. (43) AI-Based Mood Simulation Unit, that creates specific emotional atmospheres within the scene by modifying lighting effects, color gradients, and textures (e.g., cozy, vibrant, or professional). (44) An AI-Enhanced Shadow Rendering Unit, that generates or modifies shadows that are cast by the product to match its placement within the scene, ensuring realistic depth and spatial alignment. (45) Material Recognition Unit, that identifies or estimates the surface texture and material (e.g., wood, metal, fabric) of products, guiding accurate light reflection and shading in AI-generated scenes; such as, using a VLM that can recognize that the original product is metallic due to subtle light reflections thereon, or using an LLM that can determine that a product named “cooking pan” is generally made of metal (and not wood or plastic). (46) Context-Aware Object Scaling Unit, that can adjust the size of the object dynamically within the scene, ensuring it fits naturally relative to other scene elements and adheres to real-world proportions. (47) Negative Prompt Filtering Unit, that generates and/or provides and/or utilizes negative prompts to exclude unwanted elements or artifacts from the AI-generated background or scene, enhancing precision and creative control.

Some embodiments may solve or cure or prevent one or more of the following problems or disadvantages of traditional systems. (1) High Cost of Photoshoots, as the system can reduce expenses by eliminating the need for physical props, studios, and photographers, offering a faster, cost-efficient solution with AI-generated scenes and virtual staging. (2) Time-Intensive Post-Production, as the system can mitigate time delays caused by manual editing by automating background removal, lighting adjustments, and color correction, accelerating the image creation process. (3) Logistical Challenges of Photoshoots, as the system avoids the complexity of procuring/buying/delivering props and accessories and/or coordinating multiple professionals, such as stylists and photographers, by streamlining the process through AI-based virtual photoshoot tools. (4) Limited Creative Flexibility, as the system can overcome the constraints of physical environments by enabling enhanced virtual customization with text prompts that modify backgrounds, lighting, and visual effects instantly. (5) Inconsistent Lighting and Shadows, as the system can cure lighting inconsistencies by generating AI-based simulations that apply uniform lighting and shadow effects, ensuring coherent, professional-grade visuals. (6) Incomplete or Cropped Product Images, as the system can solve the problem of missing product parts by using outpainting/inpainting techniques to restore cropped or incomplete products, creating visually complete product images. (7) Visual Distortions and Placement Errors, as the system can detect and correct errors like floating objects or distorted elements by using automated correction tools that adjust size, orientation, and alignment in generated scenes. (8) Poor Image Resolution or Quality, as the system can prevent low-quality outputs by enhancing resolution and sharpness with AI upscaling algorithms, delivering high-definition product visuals. (9) Real Estate Staging Costs and Complexity, as the system can mitigate the expense and logistics of real-world staging by offering virtual staging tools that seamlessly integrate furniture and decor into photographs of empty rooms.

Some embodiments provide a process for generating product photoshoots with ai-integrated backgrounds, comprising: Receiving a product image of a real-life object; Extracting the object from the background using segmentation algorithms; Generating a new background scene based on user-provided prompts; Integrating the object into the generated scene with consistent lighting and shadows.

Some embodiments provide a process for automating background removal from product images, comprising: Receiving an input image containing a product; Identifying the object using AI-based segmentation models; Removing the background from the image while refining the object's edges; Generating a mask of the isolated product for further processing.

Some embodiments provide a process for inpainting and restoring cropped product images, comprising: Receiving an input image with a partially cropped object; Identifying missing sections of the object using edge analysis; Applying AI-based inpainting to restore the missing portions; Refining the restored object for seamless integration into new AI-generated scenes.

Some embodiments provide a process for correcting placement errors in ai-generated scenes, comprising: Integrating a photograph of a real-life object into an AI generated background; Identifying placement inconsistencies using depth mapping; Adjusting the object's size, position, and orientation within the AI generated background; Generating a corrected composite image with proper alignment.

Some embodiments provide a process for enhancing product image quality using AI upscaling, comprising: Receiving a low-resolution product image as input; Analyzing the image for graininess or blur; Applying AI-based upscaling and sharpening algorithms; Generating an enhanced version of the product image.

Some embodiments provide a process for generating adaptive virtual photoshoot scenes, comprising: Receiving a product image and product metadata; Analyzing the product's characteristics to generate scene recommendations; Generating multiple AI-based backgrounds tailored to the product; Enabling user selection and finalizing the visual appearance of the chosen scene.

Some embodiments provide a process for integrating virtual props with real-life product images, comprising: Receiving a product image; Generating virtual props relevant to the product's context; Placing the virtual props within the scene using AI-based alignment; Ensuring seamless integration with consistent shadows and lighting.

Some embodiments provide a process for detecting and correcting visual distortions in product images, comprising: Analyzing a composite image or a hybrid image for visual inconsistencies; Detecting distortions in object placement or proportion; Automatically adjusting the alignment and/or scaling of objects within the composite or hybrid image, such as by re-sizing/slanting/tilting/moving/replacing an object with an alternate/corrected/original/rescaled/tilted/slanted version thereof; Generating a corrected version of the composite image.

Some embodiments provide a process for creating realistic virtual staging for real estate marketing, comprising: Receiving an input photograph of an empty room; Analyzing the room's layout and dimensions; Generating AI-based furniture and decor items for virtual staging; Integrating the virtual items into the photograph with consistent lighting, shading, blending, and scale.

Some embodiments provide a computerized method for Artificial Intelligence (AI) based virtual product photoshoot, the computerized method comprising: (a) receiving an input photograph, that depicts a real-world object surrounded by a real-world background; (b) automatically applying a computerized background-removal process, to remove the real-world-background and to generate a background-removed image of said real-world object; (c) feeding into a Vision and Language Model (VLM) as VLM-input at least one of: (i) the background-removed image of the real-world object, (ii) the background-removed image of the real-world object; and prompting the Vision and Language Model, via Visual Question Answering (VQA) process, to analyze said VLM-input and to generate textual attributes that textually describe or pertain to said real-world object; (d) feeding the textual attributes that were generated in step (c) by the Vision and Language Model, into a Large Language Model (LLM); and prompting the LLM to generate a proposed textual prompt that will command an Image Diffusion unit to generate via Generative Artificial Intelligence (Generative-AI) an image of a scenery that would be appropriate for showcasing said real-world object; (e) feeding into an Image Diffusion unit, at least: (i) the proposed textual prompt that was generated by the LLM in step (d), and (ii) the background-removed image of the real-world object; and generating at the Image Diffusion unit a synthetic image that visually depicts said real-world object placed within a Generative-AI scenery; (f) feeding the synthetic image that was generated in step (e), into an AI-based unit that automatically recognizes visual abnormalities or visual distortions; and automatically performing by said AI-based unit a blending and refinement process that corrects recognized visual abnormalities or visual distortions and that generates a high-definition abnormality-free and distortion-free output image that depicts said real-world product blended seamlessly within said Generative-AI scenery.

In some embodiments, the computerized background-removal process is an AI-based computerized background removal process, that further includes: (A) performing AI-based analysis of the input photograph, and identifying therein one or more visually cut-off edges of said real-world object; (B) performing an AI-based out-painting process, that out-paints missing object-portions of said real-world object at said visually cut-off edges, and that creates a restored full-object background-removed image of said real-world object; wherein said restored full-object background-removed image of said real-world object is utilized as input in at least one of step (c), step (d), step (e).

In some embodiments, the blending and refinement process of step (f) comprises: (f1) automatically taking as input the background-removed real-world object; performing thereon an operation of re-sizing and/or rotating, and generating therefrom a resized/rotated version of the background-removed real-world object; (f2) automatically inserting into said synthetic image that was generated in step (e), the resized/rotated version of the background-removed real-world object that was generated in step (f1), to create the high-definition abnormality-free and distortion-free output image that depicts said real-world product blended seamlessly within said Generative-AI scenery.

In some embodiments, the blending and refinement process of step (f) comprises: modifying or adding shading effects and lighting effect, to match between (i) shading and lighting attributes of the real-world object that was placed into the Generative-AI scenery, and (ii) shading and lighting attributes of the Generative-AI scenery.

In some embodiments, the blending and refinement process of step (f) comprises: (I) analyzing the synthetic image, and generating therefrom an Inpainting Mask; (II) based on said Inpainting Mask, automatically performing an AI-based inpainting process on edges of the real-world object that was placed into the Generative-AI scenery, to generate seamless blending of the real-world object with the Generative-AI scenery.

In some embodiments, in step (d), the Large Language Model (LLM) is configured to generate a plurality of prompt-segments that cumulatively form said proposed textual prompt that is fed into the Image Diffusion unit.

In some embodiments, the plurality of prompt-segments comprises at least: (i) an LLM-generated positive-guideline textual prompt-segment, that guides the Image Diffusion unit which attributes should be featured in the synthetic image; and also, (ii) an LLM-generated negative-guideline textual prompt-segment, that guides the Image Diffusion unit which attributes should not be featured in the synthetic image.

In some embodiments, the plurality of prompt-segments further comprises: an accessory-inclusion LLM-generated textual prompt-segment that indicates to the Image Diffusion unit whether or not to virtually add one or more Generative-AI accessories or props to the synthetic image.

In some embodiments, the plurality of prompt-segments further comprises: a human-inclusion LLM-generated textual prompt-segment that indicates to the Image Diffusion unit whether or not to virtually add a Generative-AI image of a human model into the synthetic image.

In some embodiments, the plurality of prompt-segments further comprises: an LLM-generated Camera Instructions textual prompt-segment, that indicates to the Image Diffusion unit one or more camera instructions that should be simulated when the Image Diffusion unit creates the synthetic image.

In some embodiments, the plurality of prompt-segments further comprises: an LLM-generated Artistic Style textual prompt-segment, that indicates to the Image Diffusion unit one or more artistic style attributes that should be followed by the Image Diffusion unit when it creates the synthetic image.

In some embodiments, in step (e), the Image Diffusion unit is configured to perform a multiple-pass Generative-AI process that comprises: (e1) performing a high-speed low-quality Image Diffusion pass, to rapidly generate a low-quality draft synthetic image; (e2) performing AI-based analysis of visual properties of the low-quality draft synthetic image, and determining AI-generated indicators on who to correct visual abnormalities in the low-quality draft synthetic image; (e3) performing a low-speed high-quality Image Diffusion pass, to generate a high-quality synthetic image, by taking into account the AI-generated indicators from step (e2).

In some embodiments, in step (e), the Image Diffusion unit is configured to perform a multiple-pass Generative-AI process that comprises: (e1) performing a high-speed low-quality Image Diffusion pass, to rapidly generate a low-quality draft synthetic image; (e2) performing AI-based analysis of visual properties of the low-quality draft synthetic image, and creating an AI-generated Depth Mask representing spatial depth attributes of visual items within the low-quality draft synthetic image; (e3) performing a low-speed high-quality Image Diffusion pass, to generate a high-quality synthetic image, by taking into account the AI-generated Depth Mask from step (e2).

In some embodiments, in step (e), the Image Diffusion unit is configured to perform a multiple-pass Generative-AI process that comprises: (e1) performing a high-speed low-quality Image Diffusion pass, to rapidly generate a low-quality draft synthetic image; (e2) performing AI-based analysis of visual properties of the low-quality draft synthetic image, and creating an AI-generated Edges Mask representing edges and contour of objects within the low-quality draft synthetic image; (e3) performing a low-speed high-quality Image Diffusion pass, to generate a high-quality synthetic image, by taking into account the AI-generated Edges Mask from step (e2).

In some embodiments, receiving the input photograph in step (a) comprises: (a1) receiving from an end-user device, that runs a particular module, an end-user command in which a user selects a particular image that depicts a product and by which the user invokes an automated process to generate an automated AI-based virtual photoshoot of the product depicted in said particular image; wherein said particular module is a program selected from the group consisting of: a web browser, an image browsing program or a gallery-of-images browsing program, an image editing program, a social media program for browsing social media images; (a2) in response to the end-user command, that is conveyed via said particular program that runs on said end-user device, automatically performing steps (b) through (e).

In some embodiments, the method describe above further comprises: performing a computerized process for Virtual Staging of a Venue, comprising: (A) receiving an input photograph, that depicts a venue selected from the group consisting of: a room, a house, a home, an office; (B) receiving a textual prompt indicating at least (i) which features of the venue to maintain unmodified, and (ii) which accessories or props to virtually add into the venue that is depicted in the input photograph; (C) invoking an Image Diffusion unit to generate a draft synthetic image, from said input photograph, based on said textual prompt; (D) feeding the draft synthetic image that was generated in step (C), into an AI-based unit that automatically recognizes visual abnormalities or visual distortions; and automatically performing by said AI-based unit a blending and refinement process that corrects recognized visual abnormalities or visual distortions and that generates a high-definition abnormality-free and distortion-free output image that depicts AI-generated accessories and props blended seamlessly within said input image.

In some embodiments, a computerized process is provided for Virtual Staging of a Venue, comprising: (a) receiving an input photograph, that depicts a venue selected from the group consisting of: a room, a house, a home, an office; (b) receiving a textual prompt indicating at least (i) which features of the venue to maintain unmodified, and (ii) which accessories or props to virtually add into the venue that is depicted in the input photograph; (c) invoking an Image Diffusion unit to generate a draft synthetic image, from said input photograph, based on said textual prompt; (d) feeding the draft synthetic image that was generated in step (c), into an AI-based unit that automatically recognizes visual abnormalities or visual distortions; and automatically performing by said AI-based unit a blending and refinement process that corrects recognized visual abnormalities or visual distortions and that generates a high-definition abnormality-free and distortion-free output image that depicts AI-generated accessories and props blended seamlessly within said input image.

In some embodiments, step (c) of the process comprises: (c1) applying a Line Segment Detection (LSD) transformer to said input image, and generating an Edges Mask indicating contour lines of objects within said input image; (c2) applying a Depth Detection transformer to said input image, and generating a Depth Mask indicating spatial depth of objects within said input image; (c3) applying a Painting Mask transformer to said input image, and generating a Painting Mask; wherein the Painting Mask indicates: which areas of the input image can be overlaid with virtual accessories and virtual props, and which other areas of the input image should not be overlaid with virtual accessories and virtual props; (c4) feeding into the Image Diffusion unit, in addition to the input image, also the Edges Mask, the Depth Mask, and the Painting Mask; (c5) invoking the Image Diffusion unit to generate the draft synthetic image, from said input photograph, based on said textual prompt and based on the Edges Mask and the Depth Mask and the Painting Mask.

In some embodiments, step (d) of the process comprises: (d1) applying a Foreground Identification transformer to the draft synthetic image, and generating a Foreground Mask that correspond to areas of the draft synthetic image that depict AI-generated accessories and props that were introduced by the Image Diffusion unit; (d2) adding the AI-generated accessories and props, that were extracted from the draft synthetic image, back into the input image to generate a props-augmented image that depicts an original background of the venue with the AI-generated accessories.

In some embodiments, step (d) of the process further comprises: (d3) performing AI-based visual blending operations on the props-augmented image, using an AI-generated Inpaint Mask, to improve visual blending of (i) edges of the AI-generated accessories and props, and (ii) nearby surrounding areas of the original background of the venue, and to generate the high-definition output image.

Some embodiments include a non-transitory storage medium or storage article having stored thereon instructions that, when executed by a machine or a hardware processor, cause the machine or the hardware processor to perform a method as described.

Some embodiments include a system comprising: one or more hardware processors, that are configured to execute code, and that are operably associated with one or more memory units that are configured to store code; wherein the one or more hardware processors are configured to perform a method as described.

In some embodiments, in order to perform the computerized operations described above, the relevant system or devices may be equipped with suitable hardware components and/or software components; for example: a processor able to process data and/or execute code or machine-readable instructions (e.g., a central processing unit (CPU), a graphic processing unit (GPU), a digital signal processor (DSP), a processing core, an Integrated Circuit (IC), an Application-Specific IC (ASIC), one or more controllers, a logic unit, or the like); a memory unit able to store data for short term (e.g., Random Access Memory (RAM), volatile memory); a storage unit able to store data for long term (e.g., non-volatile memory, Flash memory, hard disk drive, solid state drive, optical drive); an input unit able to receive user's input (e.g., keyboard, keypad, mouse, touch-pad, touch-screen, trackball, microphone); an output unit able to generate or produce or provide output (e.g., screen, touch-screen, monitor, display unit, audio speakers); one or more transceivers or transmitters or receivers or communication units (e.g., Wi-Fi transceiver, cellular transceiver, Bluetooth transceiver, wireless communication transceiver, wired transceiver, Network Interface Card (NIC), modem); and other suitable components (e.g., a power source, an Operating System (OS), drivers, one or more applications or “apps” or software modules, or the like).

In accordance with embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, AJAX, XML, JSON, Lisp, Eiffel, Verilog, Hardware Description Language (HDL), BASIC, Visual BASIC, MATLAB, Pascal, HTML, HTML5, CSS, Perl, Python, PHP, Dart, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a legend list or a database of possible values or ranges; a comparison or matching or searching process which searches for matches and/or identical results and/or similar results among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wide Area Network (WAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

What is claimed is:

1. A computerized method for Artificial Intelligence (AI) based virtual product photoshoot, the computerized method comprising:
(a) receiving an input photograph, that depicts a real-world object surrounded by a real-world background;
(b) automatically applying a computerized background-removal process, to remove the real-world-background and to generate a background-removed image of said real-world object;
(c) feeding into a Vision and Language Model (VLM) as VLM-input at least one of: (i) the background-removed image of the real-world object, (ii) the background-removed image of the real-world object; and prompting the Vision and Language Model, via Visual Question Answering (VQA) process, to analyze said VLM-input and to generate textual attributes that textually describe or pertain to said real-world object;
(d) feeding the textual attributes that were generated in step (c) by the Vision and Language Model, into a Large Language Model (LLM); and prompting the LLM to generate a proposed textual prompt that will command an Image Diffusion unit to generate via Generative Artificial Intelligence (Generative-AI) an image of a scenery that would be appropriate for showcasing said real-world object;
(e) feeding into an Image Diffusion unit, at least: (i) the proposed textual prompt that was generated by the LLM in step (d), and (ii) the background-removed image of the real-world object;
and generating at the Image Diffusion unit a synthetic image that visually depicts said real-world object placed within a Generative-AI scenery;
(f) feeding the synthetic image that was generated in step (e), into an AI-based unit that automatically recognizes visual abnormalities or visual distortions; and automatically performing by said AI-based unit a blending and refinement process that corrects recognized visual abnormalities or visual distortions and that generates a high-definition abnormality-free and distortion-free output image that depicts said real-world product blended seamlessly within said Generative-AI scenery.

2. The computerized method of claim 1,
wherein the computerized background-removal process is an AI-based computerized background removal process, that further includes:
(A) performing AI-based analysis of the input photograph, and identifying therein one or more visually cut-off edges of said real-world object;
(B) performing an AI-based out-painting process, that out-paints missing object-portions of said real-world object at said visually cut-off edges, and that creates a restored full-object background-removed image of said real-world object;
wherein said restored full-object background-removed image of said real-world object is utilized as input in at least one of step (c), step (d), step (e).

3. The computerized method of claim 1,
wherein the blending and refinement process of step (f) comprises:
(f1) automatically taking as input the background-removed real-world object;
performing thereon an operation of re-sizing and/or rotating,
and generating therefrom a resized/rotated version of the background-removed real-world object;
(f2) automatically inserting into said synthetic image that was generated in step (e), the resized/rotated version of the background-removed real-world object that was generated in step (f1), to create the high-definition abnormality-free and distortion-free output image that depicts said real-world product blended seamlessly within said Generative-AI scenery.

4. The computerized method of claim 1,
wherein the blending and refinement process of step (f) comprises:
modifying or adding shading effects and lighting effect, to match between (i) shading and lighting attributes of the real-world object that was placed into the Generative-AI scenery, and (ii) shading and lighting attributes of the Generative-AI scenery.

5. The computerized method of claim 1,
wherein the blending and refinement process of step (f) comprises:
(I) analyzing the synthetic image, and generating therefrom an Inpainting Mask;
(II) based on said Inpainting Mask, automatically performing an AI-based inpainting process on edges of the real-world object that was placed into the Generative-AI scenery, to generate seamless blending of the real-world object with the Generative-AI scenery.

6. The computerized method of claim 1,
wherein in step (d), the Large Language Model (LLM) is configured to generate a plurality of prompt-segments that cumulatively form said proposed textual prompt that is fed into the Image Diffusion unit.

7. The computerized method of claim 6,
wherein the plurality of prompt-segments comprises at least:
(i) an LLM-generated positive-guideline textual prompt-segment, that guides the Image Diffusion unit which attributes should be featured in the synthetic image;
and also,
(ii) an LLM-generated negative-guideline textual prompt-segment, that guides the Image Diffusion unit which attributes should not be featured in the synthetic image.

8. The computerized method of claim 7,
wherein the plurality of prompt-segments further comprises:
an accessory-inclusion LLM-generated textual prompt-segment that indicates to the Image Diffusion unit whether or not to virtually add one or more Generative-AI accessories or props to the synthetic image.

9. The computerized method of claim 8,
wherein the plurality of prompt-segments further comprises:
a human-inclusion LLM-generated textual prompt-segment that indicates to the Image Diffusion unit whether or not to virtually add a Generative-AI image of a human model into the synthetic image.

10. The computerized method of claim 9,
wherein the plurality of prompt-segments further comprises:
an LLM-generated Camera Instructions textual prompt-segment, that indicates to the Image Diffusion unit one or more camera instructions that should be simulated when the Image Diffusion unit creates the synthetic image.

11. The computerized method of claim 10,
wherein the plurality of prompt-segments further comprises:
an LLM-generated Artistic Style textual prompt-segment, that indicates to the Image Diffusion unit one or more artistic style attributes that should be followed by the Image Diffusion unit when it creates the synthetic image.

12. The computerized method of claim 1,
wherein in step (e), the Image Diffusion unit is configured to perform a multiple-pass Generative-AI process that comprises:
(e1) performing a high-speed low-quality Image Diffusion pass, to rapidly generate a low-quality draft synthetic image;
(e2) performing AI-based analysis of visual properties of the low-quality draft synthetic image, and determining AI-generated indicators on who to correct visual abnormalities in the low-quality draft synthetic image;
(e3) performing a low-speed high-quality Image Diffusion pass, to generate a high-quality synthetic image, by taking into account the AI-generated indicators from step (e2).

13. The computerized method of claim 1,
wherein in step (e), the Image Diffusion unit is configured to perform a multiple-pass Generative-AI process that comprises:
(e1) performing a high-speed low-quality Image Diffusion pass, to rapidly generate a low-quality draft synthetic image;
(e2) performing AI-based analysis of visual properties of the low-quality draft synthetic image, and creating an AI-generated Depth Mask representing spatial depth attributes of visual items within the low-quality draft synthetic image;
(e3) performing a low-speed high-quality Image Diffusion pass, to generate a high-quality synthetic image, by taking into account the AI-generated Depth Mask from step (e2).

14. The computerized method of claim 1,
wherein in step (e), the Image Diffusion unit is configured to perform a multiple-pass Generative-AI process that comprises:
(e1) performing a high-speed low-quality Image Diffusion pass, to rapidly generate a low-quality draft synthetic image;
(e2) performing AI-based analysis of visual properties of the low-quality draft synthetic image, and creating an AI-generated Edges Mask representing edges and contour of objects within the low-quality draft synthetic image;
(e3) performing a low-speed high-quality Image Diffusion pass, to generate a high-quality synthetic image, by taking into account the AI-generated Edges Mask from step (e2).

15. The computerized method of claim 1,
wherein receiving the input photograph in step (a) comprises:
(a1) receiving from an end-user device, that runs a particular module, an end-user command in which a user selects a particular image that depicts a product and by which the user invokes an automated process to generate an automated AI-based virtual photoshoot of the product depicted in said particular image;
wherein said particular module is a program selected from the group consisting of:
a web browser,
an image browsing program or a gallery-of-images browsing program,
an image editing program,
a social media program for browsing social media images;
(a2) in response to the end-user command, that is conveyed via said particular program that runs on said end-user device, automatically performing steps (b) through (e).

16. The computerized method of claim 1,
further comprising:
performing a computerized process for Virtual Staging of a Venue, comprising:
(A) receiving an input photograph, that depicts a venue selected from the group consisting of: a room, a house, a home, an office;
(B) receiving a textual prompt indicating at least (i) which features of the venue to maintain unmodified, and (ii) which accessories or props to virtually add into the venue that is depicted in the input photograph;
(C) invoking an Image Diffusion unit to generate a draft synthetic image, from said input photograph, based on said textual prompt;
(D) feeding the draft synthetic image that was generated in step (C), into an AI-based unit that automatically recognizes visual abnormalities or visual distortions; and automatically performing by said AI-based unit a blending and refinement process that corrects recognized visual abnormalities or visual distortions and that generates a high-definition abnormality-free and distortion-free output image that depicts AI-generated accessories and props blended seamlessly within said input image.

17. A computerized process for Virtual Staging of a Venue, comprising:
(a) receiving an input photograph, that depicts a venue selected from the group consisting of:
a room, a house, a home, an office;
(b) receiving a textual prompt indicating at least (i) which features of the venue to maintain unmodified, and (ii) which accessories or props to virtually add into the venue that is depicted in the input photograph;
(c) invoking an Image Diffusion unit to generate a draft synthetic image, from said input photograph, based on said textual prompt;
(d) feeding the draft synthetic image that was generated in step (c), into an AI-based unit that automatically recognizes visual abnormalities or visual distortions; and automatically performing by said AI-based unit a blending and refinement process that corrects recognized visual abnormalities or visual distortions and that generates a high-definition abnormality-free and distortion-free output image that depicts AI-generated accessories and props blended seamlessly within said input image.

18. The computerized process of claim 17,
wherein step (c) comprises:
(c1) applying a Line Segment Detection (LSD) transformer to said input image, and generating an Edges Mask indicating contour lines of objects within said input image;
(c2) applying a Depth Detection transformer to said input image, and generating a Depth Mask indicating spatial depth of objects within said input image;
(c3) applying a Painting Mask transformer to said input image, and generating a Painting Mask; wherein the Painting Mask indicates: which areas of the input image can be overlaid with virtual accessories and virtual props, and which other areas of the input image should not be overlaid with virtual accessories and virtual props;
(c4) feeding into the Image Diffusion unit, in addition to the input image, also the Edges Mask, the Depth Mask, and the Painting Mask;
(c5) invoking the Image Diffusion unit to generate the draft synthetic image, from said input photograph, based on said textual prompt and based on the Edges Mask and the Depth Mask and the Painting Mask.

19. The computerized process of claim 18,
wherein step (d) comprises:
(d1) applying a Foreground Identification transformer to the draft synthetic image, and generating a Foreground Mask that correspond to areas of the draft synthetic image that depict AI-generated accessories and props that were introduced by the Image Diffusion unit;
(d2) adding the AI-generated accessories and props, that were extracted from the draft synthetic image, back into the input image to generate a props-augmented image that depicts an original background of the venue with the AI-generated accessories.

20. The computerized process of claim 19,
wherein step (d) further comprises:
(d3) performing AI-based visual blending operations on the props-augmented image, using an AI-generated Inpaint Mask, to improve visual blending of (i) edges of the AI-generated accessories and props, and (ii) nearby surrounding areas of the original background of the venue, and to generate the high-definition output image.
